(19) United States
(12) Patent Application Publication
(10) Pub. No.: US 2026/0194371 A1
(43) Pub. Date: Jul. 9, 2026

(54) MEASUREMENT RESULT ACQUIRING APPARATUS, METHOD OF ACQUIRING MEASUREMENT RESULT, AND MEASUREMENT SYSTEM

(71) Applicant: SUMITOMO ELECTRIC INDUSTRIES, LTD., Osaka-shi, Osaka (JP)

(72) Inventors: Masato IZAWA, Osaka-shi, Osaka (JP); Isao KATO, Osaka-shi, Osaka (JP); Kanata NISHIDA, Osaka-shi, Osaka (JP); Soichiro OKUMURA, Osaka-shi, Osaka (JP); Masanao YAMASHITA, Osaka-shi, Osaka (JP)

(73) Assignee: SUMITOMO ELECTRIC INDUSTRIES, LTD., Osaka-shi, Osaka (JP)

(21) Appl. No.: 19/132,378

(22) PCT Filed: Nov. 16, 2023
(86) PCT No.: PCT/JP2023/041174

§ 371 Date: May 23, 2025

(30) Foreign Application Priority Data
Dec. 2, 2022 (JP) 2022-193522

(51) Int. Cl. G01D 5/243; G01D 1/12; G01D 5/244; G01D 9/36; G01R 23/16

(52) U.S. Cl. CPC G01D 5/243; G01D 1/12; G01D 5/24404; G01D 9/36; G01R 23/16

(57) ABSTRACT

A measurement result acquiring apparatus configured to acquire measurement results of multiple sensors includes respective resonant circuits. The resonant circuits include a sensing element a characteristic of which changes depending on a physical quantity of a measurement target. The measurement result acquiring apparatus includes a signal outputting circuit configured to output a measurement signal having a component of a resonant frequency of the resonant circuits of the multiple sensors to a target line to which the multiple sensors are connected, a signal receiving circuit configured to receive, from the target line, a response signal including a reflected signal of the measurement signal, and an acquisition circuit configured to acquire the measurement result of at least one sensor among the multiple sensors, based on the response signal received by the signal receiving circuit.

### TECHNICAL FIELD

The present disclosure relates to a measurement result acquiring apparatus, a method of acquiring a measurement result, and a measurement system. The present disclosure contains subject matter related to Japanese Patent Application No. 2022-193522 filed in the Japan Patent Office on Dec. 2, 2022, the entire contents of which are incorporated herein by reference.

### BACKGROUND ART

In recent years, there has been a need for a sensing technique for quantifying information data at multiple points by using multiple sensors.

For example, PTL 1 (Japanese Unexamined Patent Application Publication No. 2021-36641) discloses a signal transmission system that serves as a system that acquires the measurement results of multiple sensors via a single transmission cable as follows. That is, the signal transmission system includes an FM demodulator that has an input terminal that is directly or indirectly connected to an end of the transmission cable and an output terminal that is connected to a host computer, one or more couplers that are inserted at intermediate positions on the transmission cable, and an FM modulator that has an output terminal that is connected to a middle tap of the one or more couplers and an input terminal that is connected to a device that outputs an analog signal and that has a carrier frequency that changes depending on the device.

PTL 2 (Japanese Unexamined Patent Application Publication No. 2018-147776) discloses a braided cable described below. That is, the braided cable is a cable that is connected to a sensor for receiving a signal from the sensor, is composed of a braided wire of wires that are connected to the sensor, includes insulating layers that are provided on the surfaces of the wires in order to prevent current flow between the wires, and enables a specific braided bundle among a large number of braided bundles to be identified by using a combination of color of the insulating layers and two indicators in a direction in which the braided bundles that are included in the braided wire are twisted.

### CITATION LIST

### Patent Literature

PTL 1: Japanese Unexamined Patent Application Publication No. 2021-36641
PTL 2: Japanese Unexamined Patent Application Publication No. 2018-147776

### SUMMARY OF INVENTION

A measurement result acquiring apparatus according to the present disclosure is configured to acquire measurement results of multiple sensor units including respective resonant circuits, the resonant circuits include a sensing element a characteristic of which changes depending on a physical quantity of a measurement target, and the measurement result acquiring apparatus includes a signal outputting unit configured to output a measurement signal having a component of a resonant frequency of the resonant circuits of the multiple sensor units to a target line to which the multiple sensor units are connected, a signal receiving unit configured to receive, from the target line, a response signal including a reflected signal of the measurement signal, and an acquisition unit configured to acquire the measurement result of at least one sensor unit among the multiple sensor units, based on the response signal received by the signal receiving unit.

### BRIEF DESCRIPTION OF DRAWINGS

FIG. 1 illustrates the structure of a sensor network according to a first embodiment of the present disclosure.

FIG. 2 illustrates the structure of sensor units according to the first embodiment of the present disclosure.

FIG. 3 illustrates the structure of a collection device according to the first embodiment of the present disclosure.

FIG. 4 illustrates an example of a measurement signal that is outputted by a signal outputting unit of the collection device according to the first embodiment of the present disclosure.

FIG. 5 illustrates the result of simulation of a power spectrum PS of a reflection signal that is received by a signal receiving unit of the collection device according to the first embodiment of the present disclosure.

FIG. 6 illustrates the result of simulation of the power spectrum PS of the reflection signal that is received by the signal receiving unit of the collection device according to the first embodiment of the present disclosure.

FIG. 7 illustrates the result of simulation of the power spectrum PS of the reflection signal that is received by the signal receiving unit of the collection device according to the first embodiment of the present disclosure.

FIG. 8 illustrates the result of simulation of the power spectrum PS of the reflection signal that is received by the signal receiving unit of the collection device according to the first embodiment of the present disclosure.

FIG. 9 illustrates an example of a correspondence table T1 that is stored by a storage unit of the collection device according to the first embodiment of the present disclosure.

FIG. 10 illustrates an example of the correspondence table T1 that is stored by the storage unit of the collection device according to the first embodiment of the present disclosure.

FIG. 11 illustrates the result of simulation of a phase spectrum HS of the reflection signal that is received by the signal receiving unit of the collection device according to the first embodiment of the present disclosure.

FIG. 12 illustrates the result of simulation of the phase spectrum HS of the reflection signal that is received by the signal receiving unit of the collection device according to the first embodiment of the present disclosure.

FIG. 13 illustrates the result of simulation of the phase spectrum HS of the reflection signal that is received by the signal receiving unit of the collection device according to the first embodiment of the present disclosure.

FIG. 14 illustrates the result of simulation of the phase spectrum HS of the reflection signal that is received by the signal receiving unit of the collection device according to the first embodiment of the present disclosure.

FIG. 15 illustrates an example of a correspondence table T2 that is stored by the storage unit of the collection device according to the first embodiment of the present disclosure.

FIG. 16 illustrates an example of the correspondence table T2 that is stored by the storage unit of the collection device according to the first embodiment of the present disclosure.

FIG. 17 illustrates a flowchart in which an example of an operating procedure when the collection device according to the first embodiment of the present disclosure acquires the measurement results of the sensor units is defined.

FIG. 18 illustrates a flowchart in which another example of the operating procedure when the collection device according to the first embodiment of the present disclosure acquires the measurement results of the sensor units is defined.

FIG. 19 illustrates the structure of a sensor network according to a second embodiment of the present disclosure.

FIG. 20 illustrates the structure of sensor units according to the second embodiment of the present disclosure.

FIG. 21 illustrates the structure of a collection device according to the second embodiment of the present disclosure.

FIG. 22 illustrates an example of the measurement signal that is outputted by the signal outputting unit of the collection device according to the second embodiment of the present disclosure.

FIG. 23 illustrates the result of simulation of the power spectrum PS of the reflection signal that is received by the signal receiving unit of the collection device according to the second embodiment of the present disclosure.

FIG. 24 illustrates the result of simulation of the power spectrum PS of the reflection signal that is received by the signal receiving unit of the collection device according to the second embodiment of the present disclosure.

FIG. 25 illustrates the result of simulation of the power spectrum PS of the reflection signal that is received by the signal receiving unit of the collection device according to the second embodiment of the present disclosure.

FIG. 26 illustrates an example of a correspondence table T3 that is stored by the storage unit of the collection device according to the second embodiment of the present disclosure.

FIG. 27 illustrates an example of the correspondence table T3 that is stored by the storage unit of the collection device according to the second embodiment of the present disclosure.

FIG. 28 illustrates the result of simulation of the phase spectrum HS of the reflection signal that is received by the signal receiving unit of the collection device according to the second embodiment of the present disclosure.

FIG. 29 illustrates the result of simulation of the phase spectrum HS of the reflection signal that is received by the signal receiving unit of the collection device according to the second embodiment of the present disclosure.

FIG. 30 illustrates the result of simulation of the phase spectrum HS of the reflection signal that is received by the signal receiving unit of the collection device according to the second embodiment of the present disclosure.

FIG. 31 illustrates an example of a correspondence table T4 that is stored by the storage unit of the collection device according to the second embodiment of the present disclosure.

FIG. 32 illustrates a flowchart in which an example of an operating procedure when the collection device according to the second embodiment of the present disclosure acquires the measurement results of the sensor units is defined.

FIG. 33 illustrates a flowchart in which another example of the operating procedure when the collection device according to the second embodiment of the present disclosure acquires the measurement results of the sensor units is defined.

### DETAILED DESCRIPTION

### Problems to be Solved by Present Disclosure

There is a need for a technique that enables measurement results at multiple points to be acquired with a simple structure beyond the techniques disclosed in PTL 1 and PTL 2.

The present disclosure has been accomplished to solve the problems described above, and it is an object of the present disclosure to provide a measurement result acquiring apparatus and a method of acquiring a measurement result that enable measurement results at multiple points to be acquired with a simple structure.

### Advantageous Effects of Present Disclosure

According to the present disclosure, measurement results at multiple points can be acquired with a simple structure.

The content of an embodiment of the present disclosure will be first listed and described.

(1) A measurement result acquiring apparatus according to the embodiment of the present disclosure is configured to acquire measurement results of multiple sensor units including respective resonant circuits, the resonant circuits include a sensing element a characteristic of which changes depending on a physical quantity of a measurement target, and the measurement result acquiring apparatus includes a signal outputting unit configured to output a measurement signal having a component of a resonant frequency of the resonant circuits of the multiple sensor units to a target line to which the multiple sensor units are connected, a signal receiving unit configured to receive, from the target line, a response signal including a reflected signal of the measurement signal, and an acquisition unit configured to acquire the measurement result of at least one sensor unit among the multiple sensor units, based on the response signal received by the signal receiving unit.

With this structure, a detecting unit that detects the result of sensing of the sensor units such as an ADC (Analog to Digital Converter) and a communication unit are not disposed for every sensor unit, and the measurement results of the sensor units can be acquired based on the component of the resonant frequency of the resonant circuits of the sensor units in the response signal that is received from the target line. Accordingly, the measurement results at multiple points can be acquired with a simple structure.

(2) As for (1) described above, resonant frequencies of the resonant circuits of the multiple sensor units may differ from each other, and the acquisition unit may acquire the measurement results of the multiple sensor units.

With this structure, the multiple measurement results can be acquired separately for every sensor unit, based on components of the resonant frequencies in the response signal.

(3) As for (2) described above, a resistance value of the sensing element may change depending on the physical quantity, and the signal outputting unit may sequentially output, to the target line, the measurement signal corresponding to every one of the multiple sensor units.

With this structure, the measurement results of the sensor units can be acquired based on the amplitude of the components of the resonant frequencies in the response signal. In addition, as for the response signal, there is no need to consider an influence of the harmonic frequency of the resonant frequency of a resonant circuit on a component of the resonant frequency of another resonant circuit, and accordingly, the resonant frequencies of the resonant circuits can be flexibly set.

(4) As for (2) described above, a resistance value of the sensing element may change depending on the physical quantity, and the signal outputting unit may output, to the target line, the measurement signal into which multiple signals having different components of the resonant frequencies are synthesized.

With this structure, the measurement results of the sensor units can be acquired based on the amplitude of the components of the resonant frequencies of the resonant circuits in the response signal. In addition, the measurement results of the multiple sensor units can be collectively acquired in a short time.

(5) As for (3) or (4) described above, the measurement result acquiring apparatus may further include a storage unit configured to store first correspondence information representing a correspondence relationship between amplitude of the response signal and the physical quantity for every one of the multiple sensor units, and the acquisition unit may acquire, as the measurement results of the multiple sensor units, the physical quantity corresponding to the amplitude of the response signal received by the signal receiving unit, based on the first correspondence information corresponding to every one of the multiple sensor units.

With this structure, more accurate measurement results for every sensor unit can be acquired based on the amplitude of the components of the resonant frequencies in the response signal.

(6) As for any one of (3) to (5) described above, the measurement result acquiring apparatus may further include a storage unit configured to store second correspondence information representing a correspondence relationship between a phase of the response signal and the physical quantity for every one of the multiple sensor units, and the acquisition unit may acquire, as the measurement results of the multiple sensor units, the physical quantity corresponding to the phase of the response signal received by the signal receiving unit, based on the second correspondence information corresponding to every one of the multiple sensor units.

With this structure, more accurate measurement results for every sensor unit can be acquired based on phase characteristics of the resonant frequencies in the response signal.

(7) As for any one of (2) to (6) described above, a capacity value of the sensing element may change depending on the physical quantity, and the signal outputting unit may sweep a frequency of the measurement signal to be outputted to the target line in a frequency range including the resonant frequencies differing from each other.

With this structure, the measurement results of the sensor units can be acquired based on a change in a frequency characteristic in the response signal.

(8) As for any one of (2) to (6) described above, a capacity value of the sensing element may change depending on the physical quantity, and the signal outputting unit may output, to the target line, the measurement signal including all frequency components in a frequency range including the resonant frequencies differing from each other.

With this structure, the measurement results of the sensor units can be acquired in a short time, based on the change in the frequency characteristic in the response signal. In addition, for example, a structure in which the measurement signal including all frequency components in the frequency range is outputted all the time enables changes in the measurement results of the sensor units to be more finely acquired than a structure in which the measurement signal is swept in the frequency range.

(9) As for (7) or (8) described above, the measurement result acquiring apparatus may further include a storage unit configured to store, for every one of the multiple sensor units, third correspondence information representing a correspondence relationship between a frequency at a change point in a power spectrum of the response signal and the physical quantity of the measurement target for every one of the multiple sensor units, and the acquisition unit may acquire, as the measurement results of the multiple sensor units, the physical quantity corresponding to the frequency at the change point in the power spectrum of the response signal received by the signal receiving unit, based on the third correspondence information corresponding to every one of the multiple sensor units.

With this structure, more accurate measurement results for every sensor unit can be acquired based on a change in a frequency characteristic of the amplitude in the response signal.

(10) As for any one of (7) to (9) described above, the measurement result acquiring apparatus may further include a storage unit configured to store, for every one of the multiple sensor units, fourth correspondence information representing a correspondence relationship between a frequency at a change point in a phase spectrum of the response signal and the physical quantity of the measurement target for every one of the multiple sensor units, and the acquisition unit may acquire, as the measurement results of the multiple sensor units, the physical quantity corresponding to the frequency at the change point in the phase spectrum of the response signal received by the signal receiving unit, based on the fourth correspondence information corresponding to every one of the multiple sensor units.

With this structure, more accurate measurement results for every sensor unit can be acquired based on a change in a frequency characteristic of the phase in the response signal.

(11) A method of acquiring a measurement result according to the embodiment of the present disclosure is a method of acquiring a measurement result for a measurement result acquiring apparatus configured to acquire measurement results of multiple sensor units including respective resonant circuits, the resonant circuits include a sensing element a characteristic of which changes depending on a physical quantity of a measurement target, and the method includes outputting a measurement signal having a component of a resonant frequency of the resonant circuits of the multiple sensor units to a target line to which the multiple sensor units are connected, and receiving, from the target line, a response signal including a reflected signal of the measurement signal; and acquiring the measurement result of at least one sensor unit among the multiple sensor units, based on the received response signal.

In this method, a detecting unit that detects the result of sensing of the sensor units such as an ADC and a communication unit are not disposed for every sensor unit, and the method enables the measurement result acquiring apparatus to acquire the measurement results of the sensor units. For example, the measurement result acquiring apparatus enables the measurement results of the sensor units to be acquired based on the component of the resonant frequency of the resonant circuits of the sensor units in the response signal that is received from the target line. Accordingly, the measurement results at multiple points can be acquired with a simple structure.

(12) A measurement system according to the embodiment of the present disclosure includes multiple sensor units including respective resonant circuits, and a measurement result acquiring apparatus configured to acquire measurement results of the multiple sensor units, the resonant circuits include a sensing element a characteristic of which changes depending on a physical quantity of a measurement target, the measurement result acquiring apparatus includes a signal outputting unit configured to output a measurement signal having a component of a resonant frequency of the resonant circuits of the multiple sensor units to a target line to which the multiple sensor units are connected, a signal receiving unit configured to receive, from the target line, a response signal including a reflected signal of the measurement signal, and an acquisition unit configured to acquire the measurement result of at least one sensor unit among the multiple sensor units, based on the response signal received by the signal receiving unit.

The measurement system enables the measurement results at multiple points to be acquired with a simple structure.

Embodiments of the present disclosure will now be described with reference to the drawings. In the drawings, portions like or corresponding to each other are designated by like reference signs, and a description thereof is not repeated. At least parts of the embodiments described below may be freely combined.

### First Embodiment

### [Structure and Basic Operation]

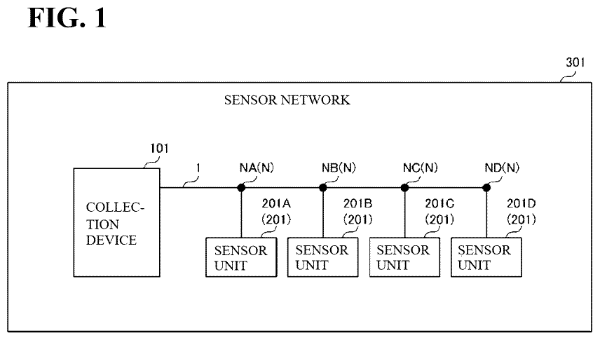

FIG. 1 illustrates the structure of a sensor network according to a first embodiment of the present disclosure. Referring to FIG. 1, a sensor network 301 includes a collection device 101 and sensor units 201A, 201B, 201C, and 201D. The sensor units 201A, 201B, 201C, and 201D are also referred to below as the sensor units 201. The collection device 101 is an example of a measurement result acquiring apparatus. The sensor network 301 is an example of a measurement system.

For example, the sensor network 301 is provided at plant equipment in a factory. The sensor network 301 may be provided at power generation equipment, a vehicle, a robot, or a building such as a house.

The collection device 101 is connected to the multiple sensor units 201 with a detection line 1 interposed therebetween. The detection line 1 is an example of a target line. For example, the detection line 1 is provided along a pipe of the plant equipment.

A first end of the detection line 1 is connected to the collection device 101, and a second end of the detection line 1 is connected to the sensor unit 201D. The detection line 1 may be a single electric wire, a twisted electric wire, or an FFC (Flexible Flat Cable) electric wire.

For example, the sensor units 201A, 201B, and 201C are connected in parallel at different positions on the detection line 1. Nodes NA, NB, NC, and ND (these are also referred to below as nodes N) are provided in order between the first end and the second end of the detection line 1. The sensor unit 201A is connected to the node NA. The sensor unit 201B is connected to the node NB. The sensor unit 201C is connected to the node NC. The sensor unit 201D is connected to the node ND.

For example, the sensor units 201 measure temperature. The temperature is an example of a physical quantity of a measurement target for the sensor units 201. The sensor units 201 may measure a physical quantity other than the temperature such as humidity. The number of the sensor units 201 is 4, but two, three, or five or more sensor units 201 may be connected to the detection line 1.

The collection device 101 performs a collection process of acquiring the measurement results of the multiple sensor units 201. For example, the collection device 101 detects an abnormality of the pipe of the plant equipment described above, based on the acquired measurement results.

### [Sensor Unit]

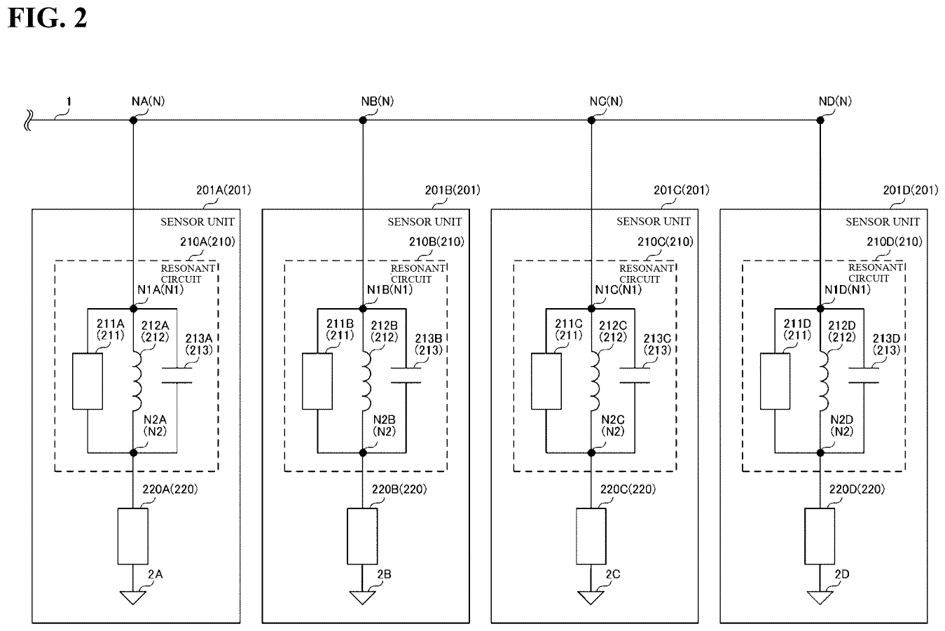

FIG. 2 illustrates the structure of the sensor units according to the first embodiment of the present disclosure. FIG. 2 illustrates equivalent circuits of the sensor units 201.

Referring to FIG. 2, the sensor unit 201A includes a resonant circuit 210A and a terminal circuit 220A. A node NIA at the resonant circuit 210A is connected to the node NA. A node N2A at the resonant circuit 210A is connected to a ground node 2A with the terminal circuit 220A interposed therebetween. The ground node 2A may be a node on a signal return path or may be a node at a chassis of a structure at which the sensor network 301 is provided. The resonant circuit 210A includes a sensing element 211A, an inductor 212A, and a capacitor 213A. The sensing element 211A, the inductor 212A, and the capacitor 213A have first ends that are connected to the node NIA and second ends that are connected to the node N2A.

The sensor unit 201B includes a resonant circuit 210B and a terminal circuit 220B. A node NIB at the resonant circuit 210B is connected to the node NB on the detection line 1. A node N2B at the resonant circuit 210B is connected to a ground node 2B with the terminal circuit 220B interposed therebetween. The resonant circuit 210B includes a sensing element 211B, an inductor 212B, and a capacitor 213B. The sensing element 211B, the inductor 212B, and the capacitor 213B have first ends that are connected to the node NIB and second ends that are connected to the node N2B.

The sensor unit 201C includes a resonant circuit 210C and a terminal circuit 220C. A node NIC at the resonant circuit 210C is connected to the node NC on the detection line 1. A node N2C at the resonant circuit 210C is connected to a ground node 2C with the terminal circuit 220C interposed therebetween. The resonant circuit 210C includes a sensing element 211C, an inductor 212C, and a capacitor 213C. The sensing element 211C, the inductor 212C, and the capacitor 213C have first ends that are connected to the node NIC and second ends that are connected to the node N2C.

The sensor unit 201D includes a resonant circuit 210D and a terminal circuit 220D. A node NID at the resonant circuit 210D is connected to the node ND on the detection line 1. A node N2D at the resonant circuit 210D is connected to a ground node 2D with the terminal circuit 220D interposed therebetween. The resonant circuit 210D includes a sensing element 211D, an inductor 212D, and a capacitor 213D. The sensing element 211D, the inductor 212D, and the capacitor 213D have first ends that are connected to the node N1D and second ends that are connected to the node N2D.

The resonant circuits 210A, 210B, 210C, and 210D are also referred to below as the resonant circuits 210. The sensing elements 211A, 211B, 211C, and 211D are also referred to below as the sensing elements 211. The inductors 212A, 212B, 212C, and 212D are also referred to below as the inductors 212. The capacitors 213A, 213D, 213C, and 213D are also referred to below as the capacitors 213. The terminal circuits 220A, 220B, 220C, and 220D are also referred to below as the terminal circuits 220. The nodes NIA, NIB, NIC, and NID are also referred to below as the node N1. The nodes N2A, N2B, N2C, and N2D are also referred to below as the node N2.

For example, the terminal circuits 220 are resistors of 50Ω equal to the characteristic impedance of the detection line 1 for matching terminals of the corresponding sensor units 201. The terminal circuits 220 may be loads other than the resistors of 50Ω and may not be used for accurately matching the terminals of the corresponding sensor units 201.

The resonant frequencies f1 of the resonant circuits 210 are expressed as an expression (1) described below.

$$f 1 = \frac{1}{2 π \sqrt{L 1 \times C 1}} \qquad ( 1 )$$

L1 is the inductance of the inductors 212. C1 is the capacitance of the capacitors 213. The resonant frequency f1 of the resonant circuit 210A is referred to below as the resonant frequency f1A. The resonant frequency f1 of the resonant circuit 210B is referred to below as the resonant frequency f1B. The resonant frequency f1 of the resonant circuit 210C is referred to below as the resonant frequency f1C. The resonant frequency f1 of the resonant circuit 210D is referred to below as the resonant frequency f1D.

For example, the sensor units 201 of the sensor network 301 include the resonant circuits 210 that have the resonant frequencies f1. The sensor units 201 have the different resonant frequencies f1. That is, the resonant frequency f1A, the resonant frequency f1B, the resonant frequency f1C, and the resonant frequency f1D differ from each other. For example, one of the resonant frequencies f1 differs by a predetermined value or more from the harmonic frequencies of the other resonant frequencies f1. For example, the predetermined value is the frequency resolution bandwidth of the collection device.

For example, as for the resonant circuit 210A, the inductance L1 of the inductor 212A is 0.1 μH, the capacitance C1 of the capacitor 213A is 0.8 μF, and the resonant frequency f1A is 562 kHz. As for the resonant circuit 210B, the inductance L1 of the inductor 212B is 0.1 μH, the capacitance C1 of the capacitor 213B is 0.5 μF, and the resonant frequency f1B is 712 kHz. As for the resonant circuit 210C, the inductance L1 of the inductor 212C is 0.1 μH, the capacitance C1 of the capacitor 213C is 0.3 μF, and the resonant frequency f1C is 919 kHz. As for the resonant circuit 210D, the inductance L1 of the inductor 212D is 0.1 μH, the capacitance C1 of the capacitor 213D is 0.1 μF, and the resonant frequency f1D is 1519 kHz.

As for the sensor units 201, the resistance values R of the resonant circuits 210 change depending on the temperature. More specifically, the sensing elements 211 have sensitivity to the temperature, and an electrical characteristic changes depending on the temperature. That is, the sensing elements 211 are capable of converting a change in the temperature into a change in the electrical characteristic. Specifically, the sensing elements 211 are resistance change elements that have the resistance values R that change depending on the temperature. For example, the sensing elements 211 are thermistors.

The resonant circuits 210 are a common kind of elements and may include elements each of which is capable of appropriately setting the electrical characteristic. With this structure, the change in the electrical characteristic of the elements enables the resonant frequencies f1 to be adjusted. More specifically, for example, the resonant circuits 210 include the sensing elements 211 that are common and the inductors 212 that are common and include variable capacitance diodes that serve as the capacitors 213. Alternatively, the resonant circuits 210 include the sensing elements 211 that are common, the inductors 212 that are common, and the capacitors 213A, 213B, 213C, and 213D that are common and that can be connected to the nodes N1 and N2 with jumper switches, for example, interposed therebetween. In this case, a user of the sensor network 301 connects the capacitor 213A of the resonant circuit 210A to the nodes NIA and N2A, connects the capacitor 213B of the resonant circuit 210B to the nodes N1B and N2B, connects the capacitor 213C of the resonant circuit 210C to the nodes NIC and N2C, and connects the capacitor 213D of the resonant circuit 210D to the nodes NID and N2D. Alternatively, the resonant circuits 210 include the sensing elements 211 that are common, the capacitors 213 that are common, and the inductors 212 that are capable of changing the inductance by using, for example, a multitap.

### [Collection Device]

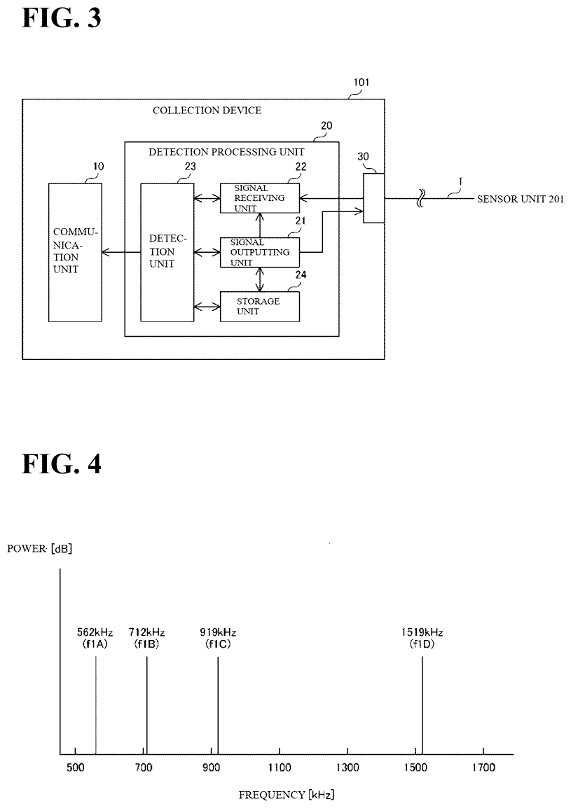

FIG. 3 illustrates the structure of the collection device according to the first embodiment of the present disclosure. Referring to FIG. 3, the collection device 101 includes a communication unit 10, a detection processing unit 20, and an input/output port 30. The detection processing unit 20 includes a signal outputting unit 21, a signal receiving unit 22, a detection unit 23, and a storage unit 24. The detection unit 23 is an example of an acquisition unit. The communication unit 10, the signal outputting unit 21, the signal receiving unit 22, and the detection unit 23 are partly or entirely constituted by, for example, a processing circuit (Circuitry) that includes one or multiple processors. An example of the storage unit 24 is a nonvolatile memory that is included in the processing circuit. An example of the input/output port 30 is a connector or a terminal. The detection line 1 is connected to the input/output port 30. The detection processing unit 20 acquires the measurement results of the sensor units 201 that are connected to the detection line 1.

### (Signal Outputting Unit)

The signal outputting unit 21 outputs a measurement signal that has a frequency component to the detection line 1. For example, the signal outputting unit 21 outputs the measurement signal to the detection line 1 via the input/output port 30.

For example, the collection device 101 regularly or irregularly performs the collection process. More specifically, the detection unit 23 determines a collection period CP during which the collection process is performed and outputs a collection instruction that represents the determined collection period CP to the signal outputting unit 21 and the signal receiving unit 22.

When the collection instruction is received from the detection unit 23, and the start time of the collection period CP that is represented by the received collection instruction comes, the signal outputting unit 21 outputs the measurement signal to the detection line 1 until the collection period CP ends.

The collection device 101 may perform the collection process all the time. In this case, the signal outputting unit 21 outputs the measurement signal to the detection line 1 all the time.

FIG. 4 illustrates an example of the power spectrum of the measurement signal that is outputted by the signal outputting unit of the collection device according to the first embodiment of the present disclosure. In FIG. 4, the horizontal axis represents frequency [KHz], and the vertical axis represents power [dB]. Referring to FIG. 4, for example, the signal outputting unit 21 outputs, to the detection line 1, the measurement signal into which multiple signals that have components of the resonant frequencies f1 of the multiple resonant circuits 210 are synthesized.

More specifically, the storage unit 24 stores N digital signals Ds1 that are acquired by digital conversion of a synthetic wave into which a sine wave at 562 kHz equal to the resonant frequency f1A, a sine wave at 712 kHz equal to the resonant frequency f1B, a sine wave at 919 kHz equal to the resonant frequency f1C, and a sine wave at 1519 kHz equal to the resonant frequency f1D are synthesized. That is, the storage unit 24 stores the digital signals Ds1 that correspond to the synthetic wave that includes components of the resonant frequencies f1A, f1B, f1C, and f1D where the number of sampling is N. N is an integer of 2 or more.

The signal outputting unit 21 includes a DA (Digital to Analog) convertor. When the start time of the collection period CP comes, the signal outputting unit 21 acquires the digital signals Ds1 from the storage unit 24 with an output timing depending on the operating clock frequency of the DA convertor until the collection period CP ends and outputs, to the detection line 1, the measurement signal that is generated by the DA convertor undergoing analog conversion of the digital signals Ds1 via the input/output port 30. The signal outputting unit 21 outputs the acquired digital signals Ds1 to the detection unit 23 and the signal receiving unit 22.

For example, the signal outputting unit 21 may include a signal generator such as a DDS (Direct Digital Synthesizer) and may output a signal that is generated by the signal generator to the detection line 1 via the input/output port 30. In this case, the signal outputting unit 21 outputs the signal that is generated by the signal generator to the detection unit 23 and the signal receiving unit 22 instead of the digital signals Ds1.

The signal receiving unit 22 receives a response signal that includes a reflected signal of the measurement signal from the detection line 1. For example, the signal receiving unit 22 receives the response signal that includes a reflection signal that is the reflected signal of the measurement signal and the measurement signal that is outputted by the signal outputting unit 21 to the detection line 1 via the input/output port 30.

More specifically, when the collection instruction is received from the detection unit 23, and the start time of the collection period CP that is represented by the received collection instruction comes, the signal receiving unit 22 receives the response signal from the detection line 1 via the input/output port 30 until the collection period CP ends.

The signal receiving unit 22 includes an AD convertor. During the collection period CP, the signal receiving unit 22 samples the response signal that is received from the detection line 1 by using the AD convertor and consequently generates digital signals Ds2 where the number of sampling is N. In the case where the collection device 101 performs the collection process all the time, the signal outputting unit 21 receives the response signal from the detection line 1 all the time and generates the digital signals Ds2 by sampling the received response signal.

For example, the signal receiving unit 22 generates digital signals Ds3 that represent the reflection signal by subtracting components of the digital signals Ds1 that are received from the signal outputting unit 21 from the generated digital signals Ds2. The signal receiving unit 22 outputs the generated digital signals Ds3 to the detection unit 23.

### (Detection Unit)

The detection unit 23 acquires the measurement result of at least one sensor unit 201 among the multiple sensor units 201, based on the response signal that is received by the signal receiving unit 22. For example, the detection unit 23 receives the digital signals Ds3 from the signal receiving unit 22 and acquires the measurement results of the multiple sensor units 201, based on the received digital signals Ds3.

### First Example of Acquisition

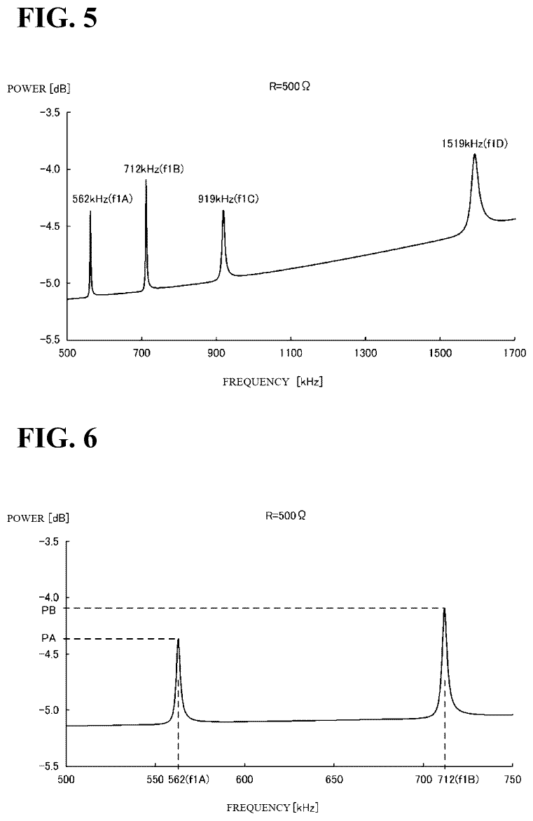

FIG. 5 illustrates the result of simulation of a power spectrum PS of the reflection signal that is received by the signal receiving unit of the collection device according to the first embodiment of the present disclosure. In FIG. 5, the horizontal axis represents the frequency [kHz], and the vertical axis represents the power [dB]. FIG. 5 illustrates the power spectrum PS in the case where the resistance values R of the sensing elements 211A, 211B, 211C, and 211D of the sensor units 201A, 201B, 201C, and 201D are 500Ω.

Referring to FIG. 5, the power spectrum PS has local maximum values at the resonant frequencies f1 of the resonant circuits 210 of the sensor units 201.

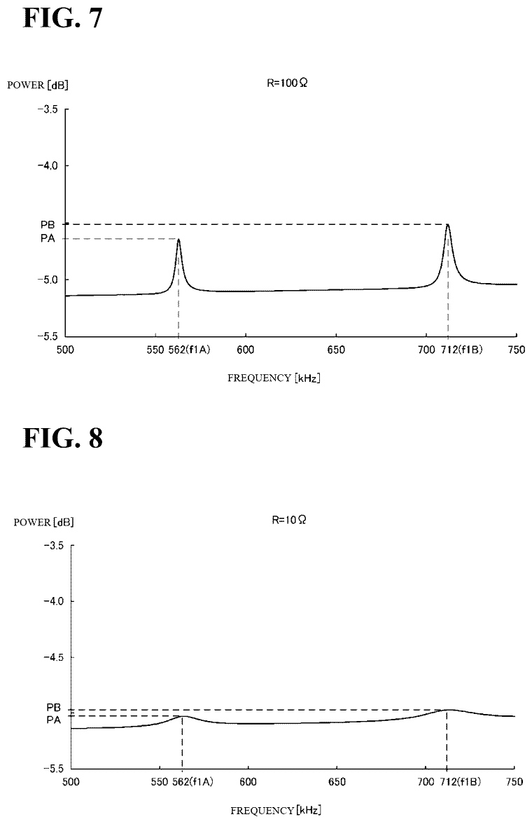

FIG. 6 to FIG. 8 illustrate the result of simulation of the power spectrum PS of the reflection signal that is received by the signal receiving unit of the collection device according to the first embodiment of the present disclosure. In FIG. 6 to FIG. 8, the horizontal axis represents the frequency [kHz], and the vertical axis represents the power [dB]. FIG. 6 is an enlarged view of a portion of the power spectrum PS in FIG. 5. FIG. 7 illustrates the power spectrum PS in the case where the resistance values R of the sensing elements 211A and 211B of the sensor units 201A and 201B are 100Ω. FIG. 8 illustrates the power spectrum PS in the case where the resistance values R of the sensing elements 211A and 211B of the sensor units 201A and 201B are 10Ω.

Referring to FIG. 6 to FIG. 8, as for the power spectrum PS, power PA and power PB that respectively correspond to the resonant frequencies f1A and f1B increase as the resistance values R of the sensing elements 211A and 211B increase. Similarly, as for the power spectrum PS, power PC and power PD that respectively correspond to the resonant frequencies f1C and f1D increase as the resistance values R of the sensing elements 211A and 211B increase. The power PA, PB, PC, and PD are also referred to below as the power P.

For example, the storage unit 24 stores a correspondence table T1 that represents a correspondence relationship between the amplitude of the response signal and the temperature that is the measurement target for the sensor units 201 for every sensor unit 201. The correspondence table T1 is an example of first correspondence information. More specifically, the storage unit 24 stores the correspondence table T1 for every resonant frequency f1. That is, the storage unit 24 stores, as the correspondence table T1, correspondence tables T1A, TIB, TIC (not illustrated), and TID (not illustrated) that respectively correspond to the sensor units 201A, 201B, 201C, and 201D.

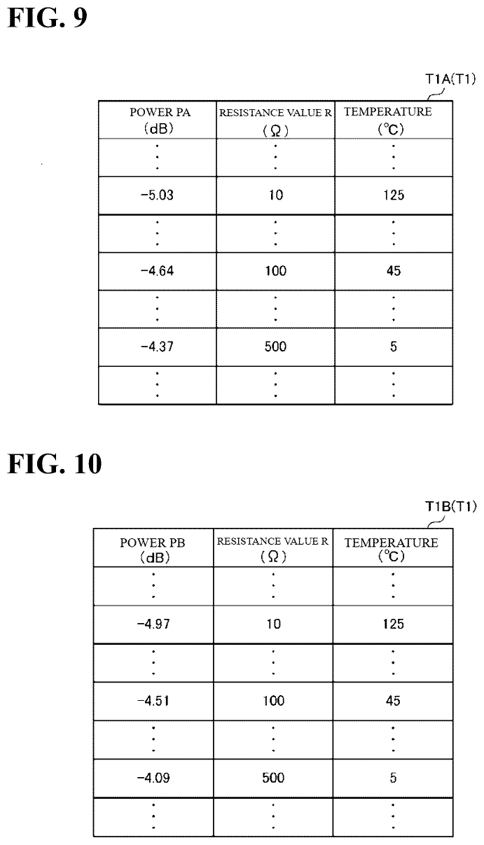

FIG. 9 and FIG. 10 illustrate examples of the correspondence table T1 that is stored by the storage unit of the collection device according to the first embodiment of the present disclosure. FIG. 9 illustrates the correspondence table TIA that corresponds to the sensor unit 201A. FIG. 10 illustrates the correspondence table T1B that corresponds to the sensor unit 201B.

Referring to FIG. 9, the storage unit 24 stores the correspondence table TIA that represents a correspondence relationship among the power PA, the resistance value R of the sensing element 211A of the sensor unit 201A, and the temperature. As for the sensing elements 211, the resistance values R change depending on the temperature as described above.

Referring to FIG. 10, the storage unit 24 stores the correspondence table T1B that represents a correspondence relationship among the power PB, the resistance value R of the sensing element 211B of the sensor unit 201B, and the temperature.

Similarly, the storage unit 24 stores the correspondence table TIC that represents a correspondence relationship among the power PC, the resistance value R of the sensing element 211C of the sensor unit 201C, and the temperature and the correspondence table TID that represents a correspondence relationship among the power PD, the resistance value R of the sensing element 211D of the sensor unit 201D, and the temperature. The storage unit 24 may store the correspondence tables TIA, TIB, TIC, and TID that do not contain the resistance values R. That is, the storage unit 24 may store the correspondence table TIA that represents a correspondence relationship between the power PA and the temperature, the correspondence table T1B that represents a correspondence relationship between the power PB and the temperature, the correspondence table TIC that represents a correspondence relationship between the power PC and the temperature, and the correspondence table TID that represents a correspondence relationship between the power PD and the temperature.

The detection unit 23 acquires, as the measurement result of each sensor unit 201, the temperature that corresponds to the amplitude of the response signal that is received by the signal receiving unit 22, based on the correspondence table T1 that corresponds to the sensor unit 201.

More specifically, the detection unit 23 generates the power spectrum PS by performing an FFT (Fast Fourier Transform) process on the digital signals Ds3 that are received from the signal receiving unit 22 and acquires the power PA, PB, PC, and PD in the generated power spectrum PS.

The detection unit 23 refers the correspondence table TA in the storage unit 24 and acquires, as a result from temperature measurement made by the sensor unit 201A, the temperature that corresponds to the power PA. More specifically, the detection unit 23 acquires, as the result from temperature measurement made by the sensor unit 201A, the temperature that corresponds to a sample closest to the value of the power PA in the power spectrum PS among samples of the power PA in the correspondence table TIA. The detection unit 23 may acquire, as the measurement result, the temperature that corresponds to a sample closest to the value and more than the value of the power PA in the power spectrum PS among the samples of the power PA in the correspondence table TIA. The detection unit 23 may acquire, as the measurement result, the temperature that corresponds to a sample closest to the value and less than the value of the power PA in the power spectrum PS among the samples of the power PA in the correspondence table TIA. The detection unit 23 may acquire, as the measurement result, a value acquired by interpolating the temperature that corresponds to the sample closest to the value of the power PA in the power spectrum PS and the temperature that corresponds to a sample second closest to the value of the power PA in the power spectrum PS among the samples of the power PA in the correspondence table TIA.

Similarly, the detection unit 23 refers the correspondence table TIB in the storage unit 24 and acquires, as a result from temperature measurement made by the sensor unit 201B, the temperature that corresponds to the power PB. The detection unit 23 refers the correspondence table TIC in the storage unit 24 and acquires, as a result from temperature measurement made by the sensor unit 201C, the temperature that corresponds to the power PC. The detection unit 23 refers the correspondence table TID in the storage unit 24 and acquires, as a result from temperature measurement made by the sensor unit 201D, the temperature that corresponds to the power PD. The detection unit 23 associates the acquired measurement results with the sensor units 201 and saves the measurement results in the storage unit 24.

For example, the value of the power P in the correspondence table T1 is corrected in advance based on the power spectrum PS that is generated by the detection unit 23 when the temperature around the sensor units 201 is set as the temperature that corresponds to the power P. Alternatively, the value of the power P in the correspondence table T1 is corrected in advance based on the result of temperature calculation with an electromagnetic field analysis model or a circuit simulator such as SPICE (Simulation Program with Integrated Circuit Emphasis).

### Second Example of Acquisition

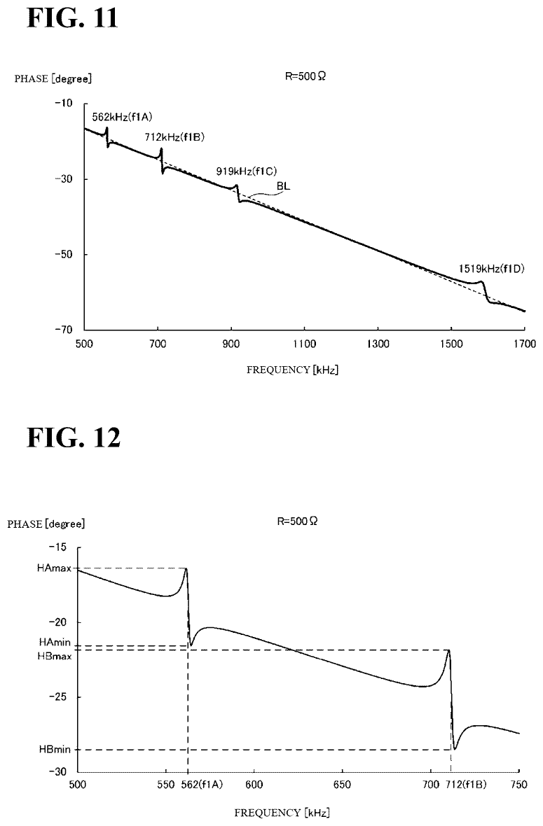

FIG. 11 illustrates the result of simulation of a phase spectrum HS of the reflection signal that is received by the signal receiving unit of the collection device according to the first embodiment of the present disclosure. In FIG. 11, the horizontal axis represents the frequency [kHz], and the vertical axis represents a phase [degree]. FIG. 11 illustrates the phase spectrum HS in the case where the resistance values R of the sensing elements 211A, 211B, 211C, and 211D of the sensor units 201A, 201B, 201C, and 201D are 500Ω. For example, the phase spectrum HS represents the spectrum of the phase of the reflection signal with respect to the measurement signal. A dashed line in FIG. 11 represents a base line BL of the phase spectrum HS. The base line BL is theoretically derived based on the length of the detection line 1 and the wavelength of the measurement signal.

Referring to FIG. 11, the phase spectrum HS has local maximum portions at which the value of the phase is higher than the base line BL and local minimum portions at which the value of the phase is lower than the base line BL at frequencies higher and lower than the resonant frequencies f1 of the resonant circuits 210 of the sensor units 201. The phase at the vertex of each local maximum portion with respect to the base line BL in the phase spectrum HS is also referred to below as the maximum phase, and the phase at the vertex of each local minimum portion with respect to the base line BL in the phase spectrum HS is also referred to below as the minimum phase. For example, the maximum phase is a local maximum value in the phase spectrum HS, and the minimum phase is a local minimum value in the phase spectrum HS. The maximum phase and the minimum phase are examples of a change point in the phase spectrum HS.

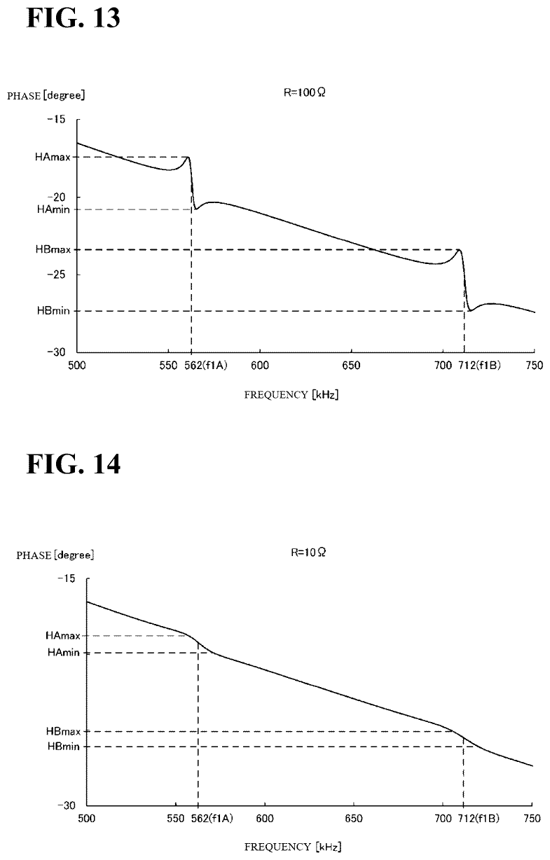

FIG. 12 to FIG. 14 illustrate the result of simulation of the phase spectrum HS of the reflection signal that is received by the signal receiving unit of the collection device according to the first embodiment of the present disclosure. In FIG. 12 to FIG. 14, the horizontal axis represents the frequency [kHz], and the vertical axis represents the phase [degree]. FIG. 12 is an enlarged view of a portion of the phase spectrum HS in FIG. 11. FIG. 13 illustrates the phase spectrum HS in the case where the resistance values R of the sensing elements 211A and 211B of the sensor units 201A and 201B are 100Ω. FIG. 14 illustrates the phase spectrum HS in the case where the resistance values R of the sensing elements 211A and 211B of the sensor units 201A and 201B are 10Ω.

Referring to FIG. 12 to FIG. 14, as for the phase spectrum HS, minimum phases HAmin and HBmin that respectively correspond to the resonant frequencies f1A and f1B decrease as the resistance values R of the sensing elements 211A and 211B increase. As for the phase spectrum HS, maximum phases HAmax and HBmax that respectively correspond to the resonant frequencies f1A and f1B increase as the resistance values R of the sensing elements 211A and 211B increase.

Similarly, as for the phase spectrum HS, minimum phases HCmin and HDmin that respectively correspond to the resonant frequencies f1C and f1D decrease as the resistance values R of the sensing elements 211C and 211D increase. Similarly, as for the phase spectrum HS, maximum phases HCmax and HDmax that respectively correspond to the resonant frequencies f1C and f1D increase as the resistance values R of the sensing elements 211C and 211D increase. The maximum phases HAmax, HBmax, HCmax, and HDmax are also referred to below as the maximum phases Hmax.

For example, the storage unit 24 stores a correspondence table T2 that represents a correspondence relationship between the phase of the response signal and the temperature that is the measurement target for the sensor units 201 for every sensor unit 201. The correspondence table T2 is an example of second correspondence information. More specifically, the storage unit 24 stores the correspondence table T2 for every resonant frequency f1. That is, the storage unit 24 stores, as the correspondence table T2, correspondence tables T2A, T2B, T2C, and T2D that respectively correspond to the sensor units 201A, 201B, 201C, and 201D.

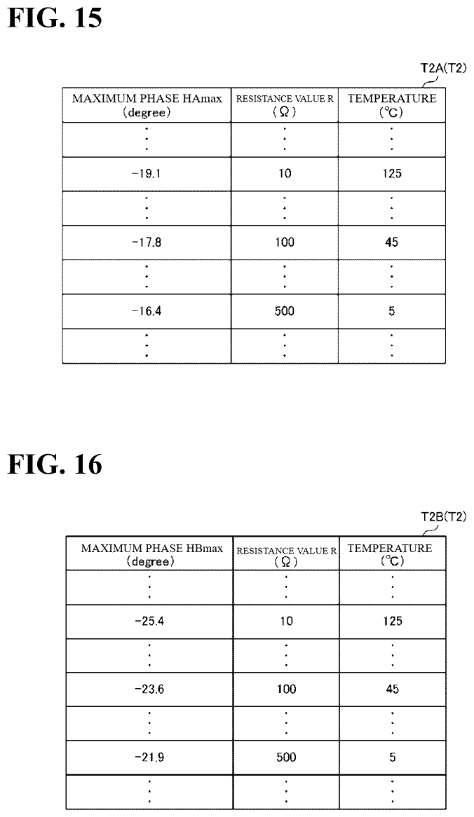

FIG. 15 and FIG. 16 illustrate examples of the correspondence table T2 that is stored by the storage unit of the collection device according to the first embodiment of the present disclosure. FIG. 15 illustrates the correspondence table T2A that corresponds to the sensor unit 201A. FIG. 16 illustrates the correspondence table T2B that corresponds to the sensor unit 201B.

Referring to FIG. 15, the storage unit 24 stores the correspondence table T2A that represents a correspondence relationship among the maximum phase HAmax, the resistance value R of the sensing element 211A of the sensor unit 201A, and the temperature.

Referring to FIG. 16, the storage unit 24 stores the correspondence table T2B that represents a correspondence relationship among the maximum phase HBmax, the resistance value R of the sensing element 211B of the sensor unit 201B, and the temperature.

Similarly, the storage unit 24 stores the correspondence table T2C that represents a correspondence relationship among the maximum phase HCmax, the resistance value R of the sensing element 211C of the sensor unit 201C, and the temperature and the correspondence table T2D that represents a correspondence relationship among the maximum phase HDmax, the resistance value R of the sensing element 211D of the sensor unit 201D, and the temperature. The storage unit 24 may store the correspondence tables T2A, T2B, T2C, and T2D that do not contain the resistance values R. That is, the storage unit 24 may store the correspondence table T2A that represents a correspondence relationship between the maximum phase HAmax and the temperature, the correspondence table T2B that represents a correspondence relationship between the maximum phase HBmax and the temperature, the correspondence table T2C that represents a correspondence relationship between the maximum phase HCmax and the temperature, and the correspondence table T2D that represents a correspondence relationship between the maximum phase HDmax and the temperature.

The detection unit 23 acquires, as the measurement result of each sensor unit 201, the temperature that corresponds to the phase of the response signal that is received by the signal receiving unit 22, based on the correspondence table T2 that corresponds to the sensor unit 201.

More specifically, the detection unit 23 generates the phase spectrum HS by performing the FFT process on the digital signals Ds3 that are received from the signal receiving unit 22 and acquires the maximum phases HAmax, HBmax, HCmax, and HDmax in the generated phase spectrum HS.

The detection unit 23 refers the correspondence table T2A in the storage unit 24 and acquires, as the result from temperature measurement made by the sensor unit 201A, the temperature that corresponds to the maximum phase HAmax. More specifically, the detection unit 23 acquires, as the result from temperature measurement made by the sensor unit 201A, the temperature that corresponds to a sample closest to the value of the maximum phase HAmax in the phase spectrum HS among samples of the maximum phase HAmax in the correspondence table T2A. The detection unit 23 may acquire, as the measurement result, the temperature that corresponds to a sample closest to the value and more than the value of the maximum phase HAmax in the phase spectrum HS among the samples of the maximum phase HAmax in the correspondence table T2A. The detection unit 23 may acquire, as the measurement result, the temperature that corresponds to a sample closest to the value and less than the value of the maximum phase HAmax in the phase spectrum HS among the samples of the maximum phase HAmax in the correspondence table T2A. The detection unit 23 may acquire, as the measurement result, a value acquired by interpolating the temperature that corresponds to the sample closest to the value of the maximum phase HAmax in the phase spectrum HS and the temperature that corresponds to a sample second closest to the value of the maximum phase HAmax in the phase spectrum HS among the samples of the maximum phase HAmax in the correspondence table T2A.

Similarly, the detection unit 23 refers the correspondence table T2B in the storage unit 24 and acquires, as the result from temperature measurement made by the sensor unit 201B, the temperature that corresponds to the maximum phase HBmax. The detection unit 23 refers the correspondence table T2C in the storage unit 24 and acquires, as the result from temperature measurement made by the sensor unit 201C, the temperature that corresponds to the maximum phase HCmax. The detection unit 23 refers the correspondence table T2D in the storage unit 24 and acquires, as the result from temperature measurement made by the sensor unit 201D, the temperature that corresponds to the maximum phase HDmax. The detection unit 23 associates the acquired measurement results with the sensor units 201 and saves the measurement results in the storage unit 24.

The storage unit 24 may store a correspondence table T2Ax that represents a correspondence relationship between the minimum phase HAmin and the temperature instead of the correspondence table T2A. In this case, the detection unit 23 acquires the minimum phase HAmin in the phase spectrum HS and acquires, as the result from temperature measurement made by the sensor unit 201A, the temperature that corresponds to the minimum phase HAmin in the correspondence table T2Ax.

The detection unit 23 may perform both of “First Example of Acquisition” and “Second Example of Acquisition” described above or may not perform one of “First Example of Acquisition” or “Second Example of Acquisition”.

### (Detection of Abnormality)

For example, the detection unit 23 compares each of the acquired measurement results and predetermined thresholds Th1 and Th2. The threshold Th1 is smaller than the threshold Th2. In the case where the measurement result is equal to or more than the threshold Th1 and the measurement result is equal to or less than the threshold Th2, the detection unit 23 determines that the environmental temperature of the detection line 1 is normal. In the case where the measurement result is less than the threshold Th1, or the measurement result is more than the threshold Th2, the detection unit 23 determines that the environmental temperature of the detection line 1 at the position of the sensor unit 201 that corresponds to the measurement result is abnormal. The detection unit 23 associates the result of determination about the environmental temperature of the detection line 1 with the sensor unit 201 and saves the result of determination in the storage unit 24.

The detection unit 23 regularly or irregularly outputs the measurement results of the sensor units 201 and the result of determination about the environmental temperature of the detection line 1 to the communication unit 10. The communication unit 10 transmits the measurement results and the result of determination that are received from the detection unit 23 to an external device outside the collection device 101.

For example, the detection unit 23 presumes the state of the progress of degradation of the pipe, not illustrated, provided along the detection line 1 and predicts the lifetime of the pipe, for example, based on the result of determination about the environmental temperature of the detection line 1.

The detection unit 23 may compare each measurement result and the threshold Th1 and may not compare the measurement result and the threshold Th2. In this case, the detection unit 23 determines that the environmental temperature of the detection line 1 is normal in the case where the measurement result is equal to or more than the threshold Th1 and determines that the environmental temperature of the detection line 1 is abnormal in the case where the measurement result is less than the threshold Th1. The detection unit 23 may compare each measurement result and the threshold Th2 and may not compare the measurement result and the threshold Th1. In this case, the detection unit 23 determines that the environmental temperature of the detection line 1 is normal in the case where the measurement result is equal to or less than the threshold Th2 and determines that the environmental temperature of the detection line 1 is abnormal in the case where the measurement result is more than the threshold Th2.

### [Operation Flow]

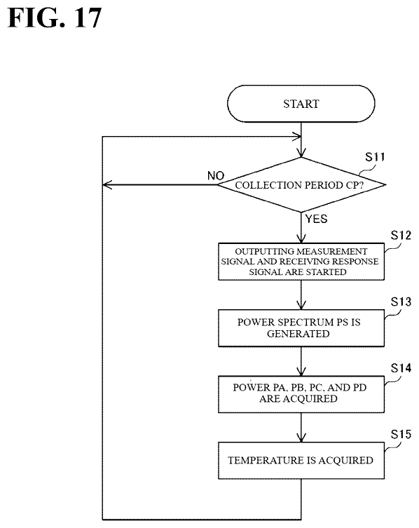

FIG. 17 illustrates a flowchart in which an example of an operating procedure when the collection device according to the first embodiment of the present disclosure acquires the measurement results of the sensor units is defined. FIG. 17 illustrates the flowchart of “First Example of Acquisition” described above.

Referring to FIG. 17, the collection device 101 first waits until the collection period CP comes (NO at a step S11) and starts outputting the measurement signal and receiving the response signal (a step S12) when the collection period CP comes (YES at the step S11).

Subsequently, the collection device 101 generates the power spectrum PS of the reflection signal that is included in the received response signal (a step S13).

Subsequently, the collection device 101 acquires the power PA, PB, PC, and PD in the generated power spectrum PS (a step S14).

Subsequently, the collection device 101 refers the correspondence table T1 and acquires the temperatures that correspond to the power PA, PB, PC, and PD. More specifically, the collection device 101 acquires, as the result from temperature measurement made by the sensor unit 201A, the temperature that corresponds to the power PA in the correspondence table TIA, acquires, as the result from temperature measurement made by the sensor unit 201B, the temperature that corresponds to the power PB in the correspondence table T1B, acquires, as the result from temperature measurement made by the sensor unit 201C, the temperature that corresponds to the power PC in the correspondence table TIC, and acquires, as the result from temperature measurement made by the sensor unit 201D, the temperature that corresponds to the power PD in the correspondence table TID (a step S15).

Subsequently, the collection device 101 waits until the collection period CP newly comes (NO at the step S11).

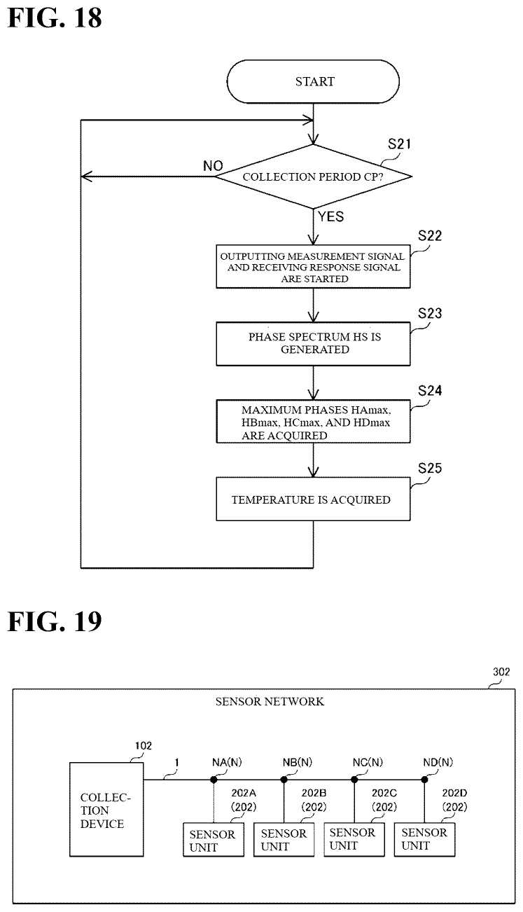

FIG. 18 illustrates a flowchart in which another example of the operating procedure when the collection device according to the first embodiment of the present disclosure acquires the measurement results of the sensor units is defined. FIG. 18 illustrates the flowchart of “Second Example of Acquisition” described above.

Referring to FIG. 18, the collection device 101 first waits until the collection period CP comes (NO at a step S21) and starts outputting the measurement signal and receiving the response signal (a step S22) when the collection period CP comes (YES at the step S21).

Subsequently, the collection device 101 generates the phase spectrum HS of the reflection signal that is included in the received response signal (a step S23).

Subsequently, the collection device 101 acquires the maximum phases HAmax, HBmax, HCmax, and HDmax in the generated phase spectrum HS (a step S24).

Subsequently, the collection device 101 refers the correspondence table T2 and acquires the temperatures that correspond to the maximum phases HAmax, HBmax, HCmax, and HDmax. More specifically, the collection device 101 acquires, as the result from temperature measurement made by the sensor unit 201A, the temperature that corresponds to the maximum phase HAmax in the correspondence table T2A, acquires, as the result from temperature measurement made by the sensor unit 201B, the temperature that corresponds to the maximum phase HBmax in the correspondence table T2B, acquires, as the result from temperature measurement made by the sensor unit 201C, the temperature that corresponds to the maximum phase HCmax in the correspondence table T2C, and acquires, as the result from temperature measurement made by the sensor unit 201D, the temperature that corresponds to the maximum phase HDmax in the correspondence table T2D (a step S25).

Subsequently, the collection device 101 waits until the collection period CP newly comes (NO at the step S21).

As for the sensor network 301 according to the first embodiment of the present disclosure, the sensor units 201 include the resonant circuits 210 that have the different resonant frequencies f1 but are not limited thereto. The sensor units 201 may include the resonant circuits 210 that have the same resonant frequency f1. In this case, the power spectrum PS has a single local maximum value, and the phase spectrum HS has a single set of the maximum phase and the minimum phase at frequencies higher and lower the resonant frequency f1. For example, the detection unit 23 acquires the power P that corresponds to the resonant frequency f1 in the power spectrum PS and acquires, as the results from temperature measurement made by the multiple sensor units 201, the temperatures that correspond to the power P in the correspondence table T1 that is shared by the sensor units 201. Alternatively, the detection unit 23 acquires the maximum phases Hmax that correspond to the resonant frequency f1 in the phase spectrum HS and acquires, as the results from temperature measurement made by the multiple sensor units 201, the temperatures that correspond to the maximum phases Hmax in the correspondence table T2 that is shared by the sensor units 201. In the case where an acquired measurement result is less than the threshold Th1 or the measurement result is more than the threshold Th2, the detection unit 23 determines that the environmental temperature of the detection line 1 at the position of any one of the sensor units 201 is abnormal.

As for the sensor network 301 according to the first embodiment of the present disclosure, the sensor units 201 are connected to the detection line 1 but are not limited thereto. The sensor units 201 may be connected to a transmission line for communication instead of the detection line 1. The transmission line is an example of the target line. In this case, for example, the collection device 101 is provided in a relay device or a communication device that is connected to the transmission line. The signal outputting unit 21 of the collection device 101 outputs the measurement signal to the transmission line. The signal receiving unit 22 of the collection device 101 receives the response signal from the transmission line.

As for the collection device 101 according to the first embodiment of the present disclosure, the signal receiving unit 22 receives the response signal that includes the reflection signal that is the reflected signal of the measurement signal and the measurement signal that is outputted by the signal outputting unit 21 from the detection line 1 via the input/output port 30 but is not limited thereto. The signal receiving unit 22 may receive the response signal that does not include the measurement signal. That is, the signal receiving unit 22 may receive, as the response signal, the reflection signal. More specifically, for example, the signal outputting unit 21 outputs the measurement signal to the detection line 1 via a directional coupler and the input/output port 30. The signal receiving unit 22 receives the response signal that does not include the measurement signal from the detection line 1 via the input/output port 30 and the directional coupler.

As for the collection device 101 according to the first embodiment of the present disclosure, the signal receiving unit 22 generates the digital signals Ds3 that represent the reflection signal by subtracting the components of the digital signals Ds1 from the digital signals Ds2 but is not limited thereto. The signal receiving unit 22 may be configured to receive the measurement signal from the signal outputting unit 21, subtract a component of the measurement signal from the received response signal, consequently generate an analog signal that represents the reflection signal, and generates the digital signals Ds3 by digital conversion of the generated analog signal.

As for the collection device 101 according to the first embodiment of the present disclosure, the signal outputting unit 21 outputs the measurement signal into which the multiple signals that have the components of the resonant frequencies f1 of the multiple resonant circuits 210 are synthesized to the detection line 1 but is not limited thereto. The signal outputting unit 21 may sequentially output multiple measurement signals that have the respective components of the resonant frequencies f1 of the multiple resonant circuits 210 to the detection line 1. More specifically, the detection unit 23 determines four collection periods CPA, CPB, CPC, and CPD into which the collection period CP is divided and outputs a collection instruction that represents the determined collection periods CPA, CPB, CPC, and CPD to the signal outputting unit 21 and the signal receiving unit 22. The signal outputting unit 21 outputs the measurement signal at 562 kHz equal to the resonant frequency f1A to the detection line 1 during the collection period CPA, outputs the measurement signal at 712 kHz equal to the resonant frequency f1B to the detection line 1 during the collection period CPB, outputs the measurement signal at 919 kHz equal to the resonant frequency f1C to the detection line 1 during the collection period CPC, and outputs the measurement signal at 1519 kHz equal to the resonant frequency f1D to the detection line 1 during the collection period CPD. The detection unit 23 acquires the measurement result of the sensor unit 201A, based on the response signal that is received by the signal receiving unit 22 during the collection period CPA, acquires the measurement result of the sensor unit 201B, based on the response signal that is received by the signal receiving unit 22 during the collection period CPB, acquires the measurement result of the sensor unit 201C, based on the response signal that is received by the signal receiving unit 22 during the collection period CPC, and acquires the measurement result of the sensor unit 201D, based on the response signal that is received by the signal receiving unit 22 during the collection period CPD.

As for the collection device 101 according to the first embodiment of the present disclosure, the storage unit 24 stores the correspondence table T1 for every sensor unit 201 but is not limited thereto. The storage unit 24 may store a single correspondence table T1 that represents a correspondence relationship between the power PA, PB, PC, and PD and the temperature and that is shared by the sensor units 201. In this case, the detection unit 23 refers the correspondence table T1, acquires, as the result from temperature measurement made by the sensor unit 201A, the temperature that corresponds to the power PA, acquires, as the result from temperature measurement made by the sensor unit 201B, the temperature that corresponds to the power PB, acquires, as the result from temperature measurement made by the sensor unit 201C, the temperature that corresponds to the power PC, and acquires, as the result from temperature measurement made by the sensor unit 201D, the temperature that corresponds to the power PD.

As for the collection device 101 according to the first embodiment of the present disclosure, the storage unit 24 stores the correspondence table T2 for every sensor unit 201 but is not limited thereto. The storage unit 24 may store a single correspondence table T2 that represents a correspondence relationship between the maximum phases HAmax, HBmax, HCmax, and HDmax and the temperature and that is shared by the sensor units 201. In this case, the detection unit 23 refers the correspondence table T2 and acquires, as the result from temperature measurement made by the sensor unit 201A, the temperature that corresponds to the maximum phase HAmax, acquires, as the result from temperature measurement made by the sensor unit 201B, the temperature that corresponds to the maximum phase HBmax, acquires, as the result from temperature measurement made by the sensor unit 201C, the temperature that corresponds to the maximum phase HCmax, and acquires, as the result from temperature measurement made by the sensor unit 201D, the temperature that corresponds to the maximum phase HDmax.

There is a need for a technique that enables the measurement results at multiple points to be acquired with a simple structure.

For example, a system that includes multiple sensor modules that include a sensing element, a detecting unit that undergoes digital conversion of an output signal from the sensing element such as an ADC, and a communication unit that transmits the acquired digital signal needs a space in which the sensor modules are disposed and increases costs. The technique disclosed in PTL 1 needs to use an FM modulator for every sensor and increases the costs.

For example, a system that sequentially acquires output signals from multiple sensing elements via a switch and undergoes digital conversion of the output signals can decrease the costs in comparison with the system that includes the sensor modules but cannot acquire a measurement result due to degradation of a cable that connects each sensing element and the switch to each other in some cases.

In contrast, as for the collection device 101 according to the first embodiment of the present disclosure, the signal outputting unit 21 outputs the measurement signal that has the components of the resonant frequencies of the resonant circuits 210 of the sensor units 201 to the detection line 1 to which the multiple sensor units 201 are connected. The resonant circuits 210 include the sensing elements 211 that have characteristics that change depending on the physical quantity of the measurement target. The signal receiving unit 22 receives the response signal that includes the reflected signal of the measurement signal from the detection line 1. The detection unit 23 acquires the measurement result of at least one sensor unit 201 among the multiple sensor units 201, based on the response signal that is received by the signal receiving unit 22.

The measurement signal is outputted to the detection line 1 to which the multiple sensor units 201 that include the sensing elements 211 are connected, and the measurement results of the sensor units 201 are acquired based on the response signal from the detection line 1 as described above. With this structure, for example, a detecting unit that detects the result of sensing of the sensor units 201 such as an ADC and a communication unit are not disposed for every sensor unit 201A, and the measurement results of the sensor units 201 can be acquired based on the components of the resonant frequencies of the resonant circuits 210 in the response signal that is received from the detection line 1. Accordingly, the measurement results at multiple points can be acquired with a simple structure.

Other embodiments of the present disclosure will now be described with reference to the drawings. In the drawings, portions like or corresponding to each other are designated by like reference signs, and a description thereof is not repeated.

### Second Embodiment

### [Structure and Basic Operation]

The present embodiment relates to a sensor network 302 that includes sensor units 202A, 202B, 202C, and 202D that have resonant frequencies f2 that change depending on the physical quantity of the measurement target in comparison with the sensor network 301 according to the first embodiment. The sensor network 302 is an example of the measurement system. Matters except for the content of the description below are the same as those of the sensor network 301 according to the first embodiment.

FIG. 19 illustrates the structure of the sensor network according to a second embodiment of the present disclosure. Referring to FIG. 19, the sensor network 302 includes a collection device 102 instead of the collection device 101 and the sensor units 202A, 202B, 202C, and 202D instead of the sensor units 201A, 201B, 201C, and 201D in comparison with the sensor network 301. The sensor units 202A, 202B, 202C, and 202D are also referred to below as the sensor units 202. The collection device 102 is an example of the measurement result acquiring apparatus.

[Sensor Unit]

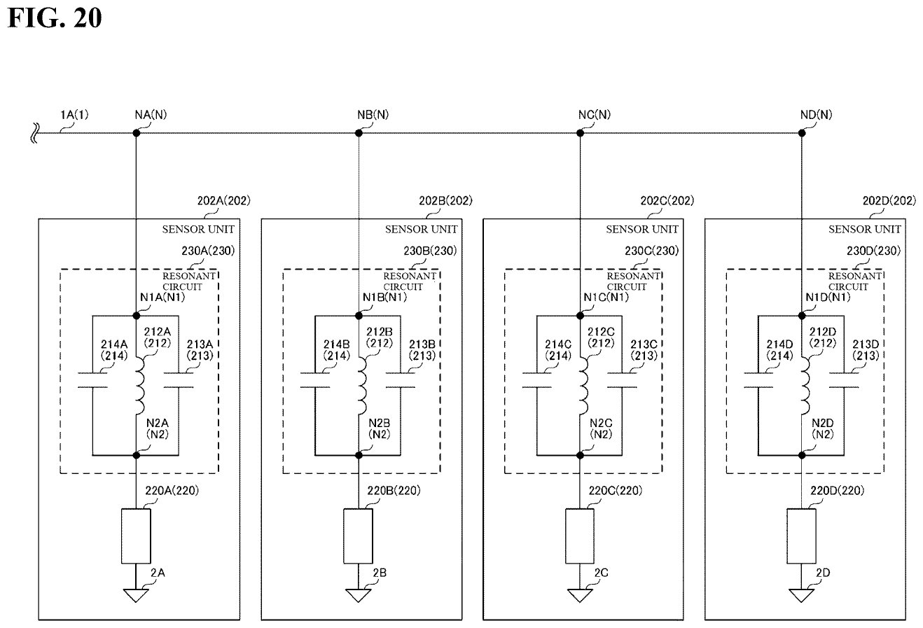

FIG. 20 illustrates the structure of the sensor units according to the second embodiment of the present disclosure. FIG. 20 illustrates equivalent circuits of the sensor units 202.

Referring to FIG. 20, the sensor unit 202A includes a resonant circuit 230A instead of the resonant circuit 210A in comparison with the sensor unit 201A. The resonant circuit 230A includes a sensing element 214A instead of the sensing element 211A in comparison with the resonant circuit 210A.

The sensor unit 202B includes a resonant circuit 230B instead of the resonant circuit 210B in comparison with the sensor unit 201B. The resonant circuit 230B includes a sensing element 214B instead of the sensing element 211B in comparison with the resonant circuit 210B.

The sensor unit 202C includes a resonant circuit 230C instead of the resonant circuit 210C in comparison with the sensor unit 201C. The resonant circuit 230C includes a sensing element 214C instead of the sensing element 211C in comparison with the resonant circuit 210C.

The sensor unit 202D includes a resonant circuit 230D instead of the resonant circuit 210D in comparison with the sensor unit 201D. The resonant circuit 230D includes a sensing element 214D instead of the sensing element 211D in comparison with the resonant circuit 210D.

The resonant circuits 230A, 230B, 230C, and 230D are also referred to below as the resonant circuits 230, and the sensing elements 214A, 214B, 214C, and 214D are also referred to below as the sensing elements 214.

The resonant frequencies f2 of the resonant circuits 230 are expressed as an expression (2) described below.

$$f 2 = \frac{1}{2 π \sqrt{L 1 \times ( C 1 + C 2 )}} \qquad ( 2 )$$

C2 is the capacitance of the sensing elements 214. The resonant frequency f2 of the resonant circuit 230A is referred to below as the resonant frequency f2A, the resonant frequency f2 of the resonant circuit 230B is referred to below as the resonant frequency f2B, the resonant frequency f2 of the resonant circuit 230C is referred to below as the resonant frequency f2C, and the resonant frequency f2 of the resonant circuit 230D is referred to below as the resonant frequency f2D.

For example, in the case where the values of the capacitance C2 of the sensing elements 214 are equal to each other, the resonant circuits 230 of the sensor units 202 have the different resonant frequencies f2. In this case, the resonant frequencies f2 can differ from each other when the values of the inductance L1, the capacitance C1, or both differ from each other. That is, in the case where the values of the capacitance C2 of the sensing elements 214A, 214B, 214C, and 214D are equal to each other, the resonant frequency f2A, the resonant frequency f2B, the resonant frequency f2C, and the resonant frequency f2D differ from each other. For example, in the case where the values of the capacitance C2 of the sensing elements 214A, 214B, 214C, and 214D are equal to each other, one of the resonant frequencies f2 differs by a predetermined value or more from the harmonic frequencies of the other resonant frequencies f2.

As for the sensor units 202, the capacity values of the resonant circuits 230 change depending on the temperature. More specifically, the sensing elements 214 have sensitivity to the temperature, and the electrical characteristic changes depending on the temperature. Specifically, the sensing elements 214 are capacitance change elements that have the capacitance C2 that changes depending on the temperature.

### [Collection Device]

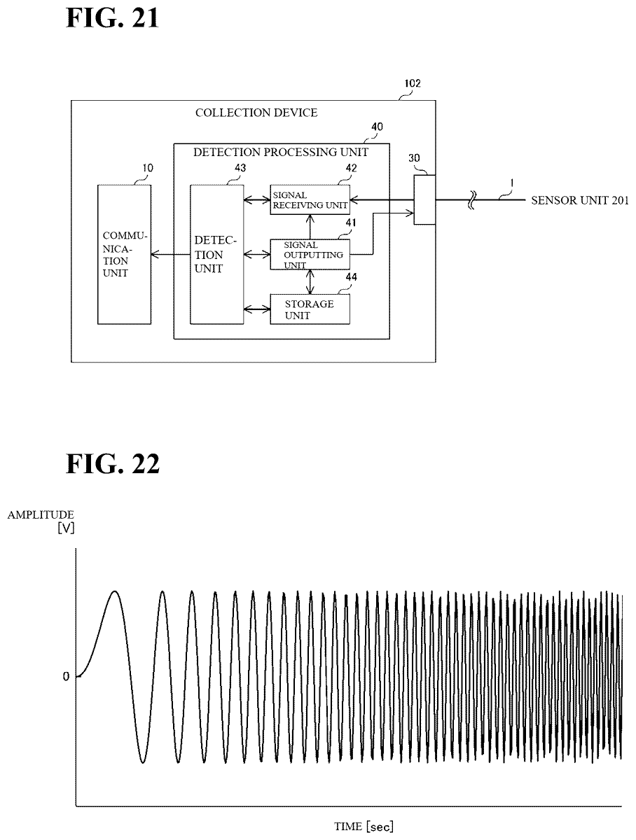

FIG. 21 illustrates the structure of the collection device according to the second embodiment of the present disclosure. Referring to FIG. 21, the collection device 102 includes a detection processing unit 40 instead of the detection processing unit 20 in comparison with the collection device 101. The detection processing unit 40 includes a signal outputting unit 41 instead of the signal outputting unit 21, includes a signal receiving unit 42 instead of the signal receiving unit 22, a detection unit 43 instead of the detection unit 23, and a storage unit 44 instead of the storage unit 24. The detection unit 43 is an example of the acquisition unit. The communication unit 10, the signal outputting unit 41, the signal receiving unit 42, and the detection unit 43 are partly or entirely constituted by, for example, a processing circuit that includes one or multiple processors. For example, the storage unit 44 is a nonvolatile memory that is included in the processing circuit described above. The detection processing unit 40 acquires the measurement results of the sensor units 202 that are connected to the detection line 1.

### (Signal Outputting Unit)

FIG. 22 illustrates an example of the measurement signal that is outputted by the signal outputting unit of the collection device according to the second embodiment of the present disclosure. In FIG. 22, the horizontal axis represents time [sec], and the vertical axis represents the amplitude [V] of the measurement signal. Referring to FIG. 22, for example, the signal outputting unit 41 sweeps the frequency of the measurement signal that is outputted to the detection line 1 in a frequency range that includes the resonant frequencies f2A, f2B, f2C, and f2D.

More specifically, the storage unit 44 stores N digital signals Ds4 that are acquired by digital conversion of a sine wave the frequency of which increases in proportion to the time. That is, the storage unit 24 stores the digital signals Ds4 that correspond to a frequency sweep signal where the number of sampling is N.

The signal outputting unit 41 includes a DA convertor. When the start time of the collection period CP comes, the signal outputting unit 41 acquires the digital signals Ds4 from the storage unit 44 with an output timing depending on the operating clock frequency of the DA convertor until the collection period CP ends and outputs, to the detection line 1, the measurement signal that is generated by the DA convertor undergoing analog conversion of the digital signals Ds4 via the input/output port 30. The signal outputting unit 41 outputs the acquired digital signals Ds4 to the detection unit 43 and the signal receiving unit 42.

### (Signal Receiving Unit)

When the start time of the collection period CP comes, the signal receiving unit 42 receives the response signal from the detection line 1 via the input/output port 30 until the collection period CP ends.

The signal receiving unit 42 includes an AD convertor. During the collection period CP, the signal receiving unit 42 samples the response signal that is received from the detection line 1 by using the AD convertor and consequently generates digital signals Ds5 where the number of sampling is N.

For example, the signal receiving unit 42 generates digital signals Ds6 that represent the reflection signal by subtracting components of the digital signals Ds4 that are received from the signal outputting unit 41 from the generated digital signals Ds5. The signal receiving unit 42 outputs the generated digital signals Ds6 to the detection unit 43.

### (Detection Unit)

The detection unit 43 acquires the measurement result of at least one sensor unit 202 among the multiple sensor units 202, based on the response signal that is received by the signal receiving unit 42. For example, the detection unit 43 receives the digital signals Ds6 from the signal receiving unit 42 and acquires the measurement results of the multiple sensor units 202, based on the received digital signals Ds6.

### (Third Example of Acquisition)

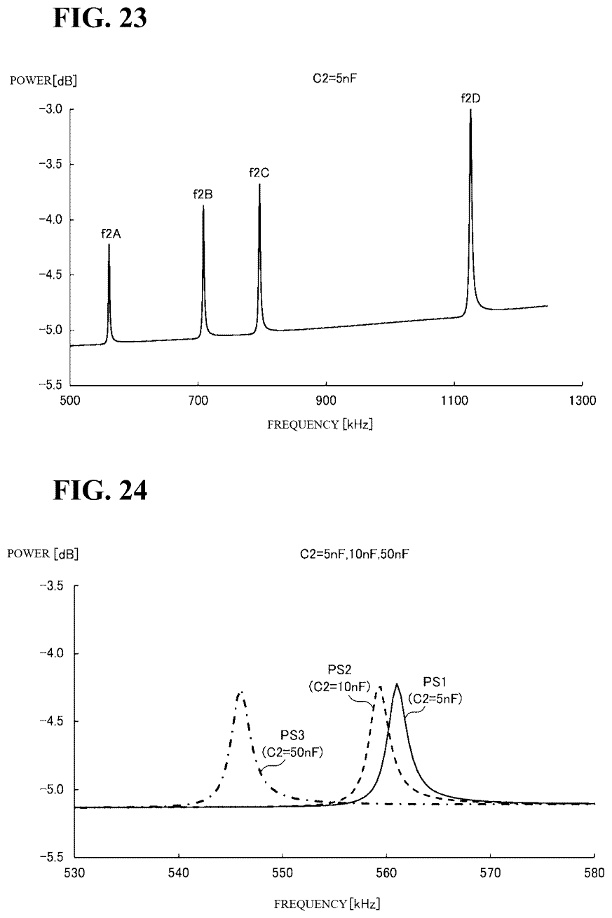

FIG. 23 illustrates the result of simulation of the power spectrum PS of the reflection signal that is received by the signal receiving unit of the collection device according to the second embodiment of the present disclosure. In FIG. 23, the horizontal axis represents the frequency [kHz], and the vertical axis represents the power [dB]. FIG. 23 illustrates the power spectrum PS in the case where the capacitance C2 of the sensing elements 214A, 214B, 214C, and 214D of the sensor units 202A, 202B, 202C, and 202D is 5 nF. The values of the inductance L1 and the capacitance C1 of the sensor units 202 are equal to those of the inductance L1 and the capacitance C1 of the sensor units 201 according to the first embodiment.

Referring to FIG. 23, the power spectrum PS has local maximum values at the resonant frequencies f2 of the resonant circuits 230 of the sensor units 202. The local maximum values are examples of a change point in the power spectrum PS.

FIG. 24 illustrates the result of simulation of the power spectrum PS of the reflection signal that is received by the signal receiving unit of the collection device according to the second embodiment of the present disclosure. In FIG. 24, the horizontal axis represents the frequency [kHz], and the vertical axis represents the power [dB]. FIG. 24 illustrates the power spectrum PS in a frequency region that includes the resonant frequency f2A. In FIG. 24, a solid line represents a power spectrum PS1 in the case where the capacitance C2 of the sensing element 211A is 5 nF, a dashed line represents a power spectrum PS2 in the case where the capacitance C2 of the sensing element 211A is 10 nF, and a one-dot chain line represents a power spectrum PS3 in the case where the capacitance C2 of the sensing element 211A is 50 nF.

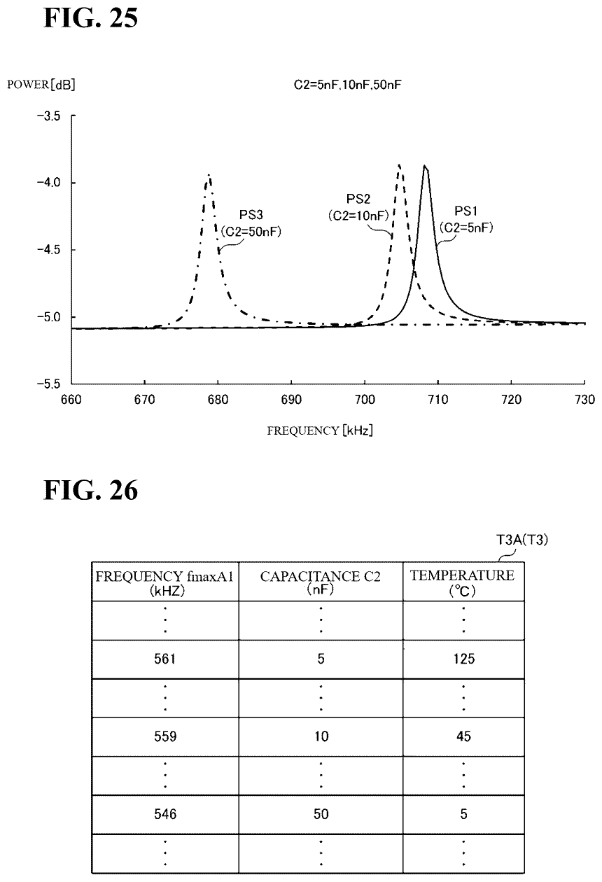

FIG. 25 illustrates the result of simulation of the power spectrum PS of the reflection signal that is received by the signal receiving unit of the collection device according to the second embodiment of the present disclosure. In FIG. 25, the horizontal axis represents the frequency [KHz], and the vertical axis represents the power [dB]. FIG. 25 illustrates the power spectrum PS in a frequency region that includes the resonant frequency f2B. In FIG. 25, a solid line represents the power spectrum PS1 in the case where the capacitance C2 of the sensing element 211B is 5 nF, a dashed line represents the power spectrum PS2 in the case where the capacitance C2 of the sensing element 211B is 10 nF, and a one-dot chain line represents the power spectrum PS3 in the case where the capacitance C2 of the sensing element 211B is 50 nF.

Referring to FIG. 24 and FIG. 25, as for the power spectrum PS, frequency fmaxA1 and fmaxB1 that correspond to the local maximum values of the power, that is, the resonant frequencies f2A and f2B decrease as the capacitance C2 of the sensing elements 214A and 214B increases. Similarly, as for the power spectrum PS, frequency fmaxC1 and fmaxD1 that correspond to the local maximum values of the power, that is, the resonant frequency f2C and f2D decrease as the capacitance C2 of the sensing elements 214C and 214D increases. The frequencies fmaxA1, fmaxB1, fmaxC1, and fmaxD1 are also referred to below as the frequencies fmax.

The ranges of the values that the capacitance C2 of the sensing elements 214 can have and the ranges of the values that the resonant frequencies f2 can have are determined in advance depending on the ranges of the values that the temperatures at the corresponding sensor units 202 can have. The ranges of the values that the resonant frequencies f2A, f2B, f2C, and f2D can have are referred to below as the frequency ranges RIA, R1B, RIC, and RID. The frequency ranges RIA, RIB, RIC, and RID are also referred to as the frequency ranges R1. For example, the resonant frequencies f2 are set in advance such that the frequency ranges R1 do not overlap. The resonant frequencies f2 may be set such that the frequency ranges R1 partly overlap.

For example, the storage unit 44 stores the correspondence table T3 that represents a correspondence relationship between the frequency when the amplitude of the response signal has the maximum value and the temperature that is the measurement target for the sensor units 202 for every sensor unit 202. The correspondence table T3 is an example of third correspondence information. More specifically, the storage unit 44 stores the correspondence table T3 for every frequency range R1. That is, the storage unit 44 stores, as the correspondence table T3, correspondence tables T3A, T3B, T3C, and T3D that respectively correspond to the sensor units 202A, 202B, 202C, and 202D.

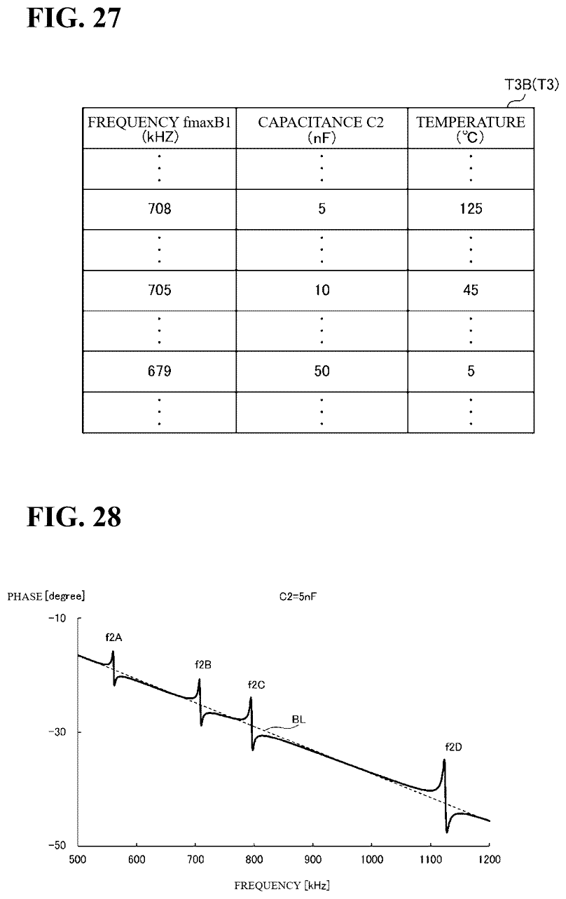

FIG. 26 and FIG. 27 illustrate examples of the correspondence table T3 that is stored by the storage unit of the collection device according to the second embodiment of the present disclosure. FIG. 26 illustrates the correspondence table T3A that corresponds to the sensor unit 202A. FIG. 27 illustrates the correspondence table T3B that corresponds to the sensor unit 202B.

Referring to FIG. 26, the storage unit 44 stores the correspondence table T3A that represents a correspondence relationship among the frequency fmaxA1 when the power has a local maximum value in the frequency range RIA, the capacitance C2 of the sensing element 214A of the sensor units 202A, and the temperature. As for the sensing elements 214, the capacitance C2 changes depending on the temperature as described above.

Referring to FIG. 27, the storage unit 44 stores the correspondence table T3B that represents a correspondence relationship among the frequency fmaxB1 when the power has a local maximum value in the frequency range RIB, the capacitance C2 of the sensing element 214B of the sensor unit 202B, and the temperature.

Similarly, the storage unit 44 stores the correspondence table T3C that represents a correspondence relationship among the frequency fmaxC1 when the power has a local maximum value in the frequency range RIC, the capacitance C2 of the sensing element 214C of the sensor unit 202C, and the temperature and the correspondence table T3D that represents a correspondence relationship among the frequency fmaxD1 when the power has a local maximum value in the frequency range RID, the capacitance C2 of the sensing element 214D of the sensor unit 202D, and the temperature. The storage unit 44 may store the correspondence tables T3A, T3B, T3C, and T3D that do not contain the capacitance C2. That is, the storage unit 44 may store the correspondence table T3A that represents a correspondence relationship between the frequency fmaxA1 and the temperature, the correspondence table T3B that represents a correspondence relationship between the frequency fmaxB1 and the temperature, the correspondence table T3C that represents a correspondence relationship between the frequency fmaxC1 and the temperature, and the correspondence table T3D that represents a correspondence relationship between the frequency fmaxD1 and the temperature. The storage unit 44 may store a correspondence table that represents, for example, a correspondence relationship between an inflection point in the power spectrum PS and the temperature for every frequency range R1 instead of the correspondence tables T3A, T3B, T3C, and T3D.

The detection unit 43 acquires, as the measurement result of each sensor unit 202, the temperature that corresponds to the frequency when the amplitude of the response signal that is received by the signal receiving unit 42 has the maximum value, based on the correspondence table T3 that corresponds to the sensor unit 202.

More specifically, the detection unit 43 generates the power spectrum PS by performing the FFT process on the digital signals Ds6 that are received from the signal receiving unit 42 and acquires the frequencies fmaxA1, fmaxB1, fmaxC1, and fmaxD1 in the generated power spectrum PS.

The detection unit 43 refers the correspondence table T3A in the storage unit 44 and acquires, as a result from temperature measurement made by the sensor unit 202A, the temperature that corresponds to the frequency fmaxA1. More specifically, the detection unit 43 acquires, as the result from temperature measurement made by the sensor unit 202A, the temperature that corresponds to a sample closest to the value of the frequency fmaxA1 in the power spectrum PS among samples of the frequency fmaxA1 in the correspondence table T3A. The detection unit 43 may acquire, as the measurement result, the temperature that corresponds to a sample closest to the value and more than the value of the frequency fmaxA1 in the power spectrum PS among the samples of the frequency fmaxA1 in the correspondence table T3A. The detection unit 43 may acquire, as the measurement result, the temperature that corresponds to a sample closest to the value and less than the value of the frequency fmaxA1 in the power spectrum PS among the samples of the frequency fmaxA1 in the correspondence table T3A. The detection unit 43 may acquire, as the measurement result, a value acquired by interpolating the temperature that corresponds to the sample closest to the value of the frequency fmaxA1 in the power spectrum PS and the temperature that corresponds to a sample second closest to the value of the frequency fmaxA1 in the power spectrum PS among the samples of the frequency fmaxA1 in the correspondence table T3A.

Similarly, the detection unit 43 refers the correspondence table T3B in the storage unit 44 and acquires, as a result from temperature measurement made by the sensor unit 202B, the temperature that corresponds to the frequency fmaxB1. The detection unit 43 refers the correspondence table T3C in the storage unit 44 and acquires, as a result from temperature measurement made by the sensor unit 202C, the temperature that corresponds to the frequency fmaxC1. The detection unit 43 refers the correspondence table T3D in the storage unit 44 and acquires, as a result from temperature measurement made by the sensor unit 202D, the temperature that corresponds to the frequency fmaxD1. The detection unit 43 associates the acquired measurement results with the sensor units 202 and saves the measurement results in the storage unit 44.

### Fourth Example of Acquisition

FIG. 28 illustrates the result of simulation of the phase spectrum HS of the reflection signal that is received by the signal receiving unit of the collection device according to the second embodiment of the present disclosure. In FIG. 28, the horizontal axis represents the frequency [kHz], and the vertical axis represents the phase [degree]. FIG. 28 illustrates the phase spectrum HS in the case where the capacitance C2 of the sensing elements 214A, 214B, 214C, and 214D of the sensor units 202A, 202B, 202C, and 202D is 5 nF. A dashed line in FIG. 28 represents the base line BL of the phase spectrum HS.

Referring to FIG. 28, the phase spectrum HS has local maximum portions at which the value of the phase is higher than the base line BL and local minimum portions at which the value of the phase is lower than the base line BL at frequencies higher and lower than the resonant frequencies f2 of the resonant circuits 230 of the sensor units 202.

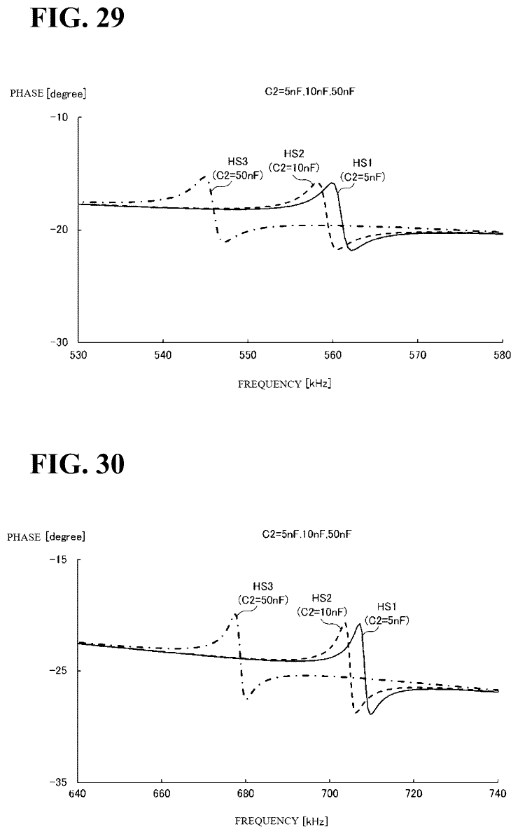

FIG. 29 illustrates the result of simulation of the phase spectrum HS of the reflection signal that is received by the signal receiving unit of the collection device according to the second embodiment of the present disclosure. In FIG. 29, the horizontal axis represents the frequency [kHz], and the vertical axis represents the phase [degree]. FIG. 29 represents the phase spectrum HS in a frequency region that includes the resonant frequency f2A. In FIG. 29, a solid line represents a phase spectrum HS1 in the case where the capacitance C2 of the sensing element 214A is 5 nF, a dashed line represents a phase spectrum HS2 in the case where the capacitance C2 of the sensing element 211A is 10 nF, and a one-dot chain line represents a phase spectrum HS3 in the case where the capacitance C2 of the sensing element 211A is 50 nF.

FIG. 30 illustrates the result of simulation of the phase spectrum HS of the reflection signal that is received by the signal receiving unit of the collection device according to the second embodiment of the present disclosure. In FIG. 30, the horizontal axis represents the frequency [KHz], and the vertical axis represents the phase [degree]. FIG. 30 illustrates the phase spectrum HS in a frequency region that includes the resonant frequency f2B. In FIG. 30, a solid line represents the phase spectrum HS1 in the case where the capacitance C2 of the sensing element 214B is 5 nF, a dashed line represents the phase spectrum HS2 in the case where the capacitance C2 of the sensing element 211B is 10 nF, and a one-dot chain line represents the phase spectrum HS3 in the case where the capacitance C2 of the sensing element 211B is 50 nF. The values of the inductance L1 and the capacitance C1 of the sensor units 202 are equal to those of the inductance L1 and the capacitance C1 of the sensor units 201 according to the first embodiment.

Referring to FIGS. 29 and 30, as for the phase spectrum HS, frequencies fminA and fminB that correspond to the minimum phases HAmin and HBmin and frequencies fmaxA2 and fmaxB2 that correspond to the maximum phases HAmax and HBmax decrease as the capacitance C2 of the sensing elements 214A and 214B increases. Similarly, as for the phase spectrum HS, frequencies fminC and fminD that correspond to the minimum phases HCmin and HDmin and frequencies fmaxC2 and fmaxD2 that correspond to the maximum phases HCmax and HDmax decrease as the capacitance C2 of the sensing elements 214C and 214D increases. The frequencies fminA, fminB, fminC, and fminD are also referred to below as the frequencies fmin, and the frequencies fmaxA2, fmaxB2, fmaxC2, and fmaxD2 are also referred to below as the frequencies fmax2.

The ranges of the values that the capacitance C2 of the sensing elements 214 can have, the ranges of the values that the frequencies fmin can have, and the ranges of the values that the frequencies fmax2 can have are determined in advance depending on the ranges of the values that the temperatures at the corresponding sensor units 202 can have. The ranges of the values that the frequencies fmaxA2, fmaxB2, fmaxC2, and fmaxD2 can have are referred to below as the frequency ranges R2A, R2B, R2C, and R2D. The frequency ranges R2A, R2B, R2C, and R2D are also referred to as the frequency ranges R2. For example, the resonant frequencies f2 are set in advance such that the frequency ranges R2 do not overlap. The resonant frequencies f2 may be set such that the frequency ranges R2 partly overlap.

For example, the storage unit 44 stores the correspondence table T4 that represents a correspondence relationship between the frequency when the phase of the response signal has an extreme value and the temperature that is the measurement target for the sensor units 202 for every sensor unit 202. The correspondence table T4 is an example of fourth correspondence information. More specifically, the storage unit 44 stores the correspondence table T4 for every frequency range R2. That is, the storage unit 44 stores, as the correspondence table T4, correspondence tables T4A, T4B, T4C, and T4D that respectively correspond to the sensor units 202A, 202B, 202C, and 202D.

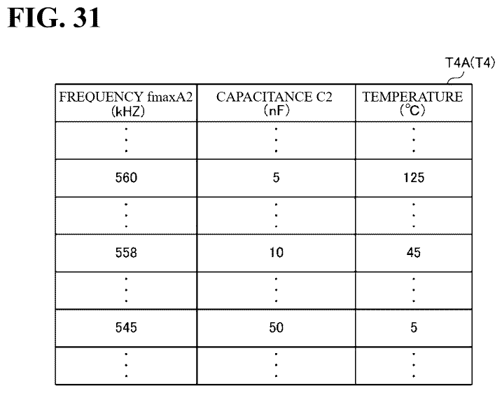

FIG. 31 illustrates an example of the correspondence table T4 that is stored by the storage unit of the collection device according to the second embodiment of the present disclosure. FIG. 31 illustrates the correspondence table T4A that corresponds to each sensor unit 202A.

Referring to FIG. 31, the storage unit 44 stores the correspondence table T4A that represents a correspondence relationship among the frequency fmaxA2 when the phase has a local maximum value in the frequency range R2A, the capacitance C2 of the sensing element 214A of the sensor unit 202A, and the temperature.

The storage unit 44 stores the correspondence table T4B that represents a correspondence relationship among the frequency fmaxB2 when the phase has a local maximum value in the frequency range R2B, the capacitance C2 of the sensing element 214B of the sensor unit 202B, and the temperature, the correspondence table T4C that represents a correspondence relationship among the frequency fmaxC2 when the phase has a local maximum value in the frequency range R2C, the capacitance C2 of the sensing element 214C of the sensor unit 202C, and the temperature, and the correspondence table T4D that represents a correspondence relationship among the frequency fmaxD2 when the phase has a local maximum value in the frequency range R2D, the capacitance C2 of the sensing element 214D of the sensor unit 202D, and the temperature. The storage unit 44 may store the correspondence tables T4A, T4B, T4C, and T4D that do not contain the capacitance C2. That is, the storage unit 44 may store the correspondence table T4A that represents a correspondence relationship between the frequency fmaxA2 and the temperature, the correspondence table T4B that represents a correspondence relationship between the frequency fmaxB2 and the temperature, the correspondence table T4C that represents a correspondence relationship between the frequency fmaxC2 and the temperature, and the correspondence table T4D that represents a correspondence relationship between the frequency fmaxD2 and the temperature. The storage unit 44 may store a correspondence table that represents, for example, a correspondence relationship between an inflection point in the phase spectrum HS and the temperature for every frequency range R2 instead of the correspondence tables T4A, T4B, T4C, and T4D.

The detection unit 43 acquires, as the measurement result of each sensor unit 202, the temperature that corresponds to the frequency when the phase of the response signal that is received by the signal receiving unit 42 has an extreme value, based on the correspondence table T4 that corresponds to the sensor unit 202.

More specifically, the detection unit 43 generates the phase spectrum HS by performing the FFT process on the digital signals Ds6 that are received from the signal receiving unit 42 and acquires the frequencies fmaxA2, fmaxB2, fmaxC2, and fmaxD2 in the generated phase spectrum HS.

The detection unit 43 refers the correspondence table T4A in the storage unit 44 and acquires, as the result from temperature measurement made by the sensor unit 202A, the temperature that corresponds to the frequency fmaxA2. More specifically, the detection unit 43 acquires, as the result from temperature measurement made by the sensor unit 202A, the temperature that corresponds to a sample closest to the value of the frequency fmaxA2 in the phase spectrum HS among samples of the frequency fmaxA2 in the correspondence table T4A. The detection unit 43 may acquire, as the measurement result, the temperature that corresponds to a sample closest to the value and more than the value of the frequency fmaxA2 in the phase spectrum HS among the samples of the frequency fmaxA2 in the correspondence table T4A. The detection unit 43 may acquire, as the measurement result, the temperature that corresponds to a sample closest to the value and less than the value of the frequency fmaxA2 in the phase spectrum HS among the samples of the frequency fmaxA2 in the correspondence table T4A. The detection unit 43 may acquire, as the measurement result, a value acquired by interpolating the temperature that corresponds to the sample closest to the value of the frequency fmaxA2 in the phase spectrum HS and the temperature that corresponds to a sample second closest to the value of the frequency fmaxA2 in the phase spectrum HS among the samples of the frequency fmaxA2 in the correspondence table T4A.

Similarly, the detection unit 43 refers the correspondence table T4B in the storage unit 44 and acquires, as the result from temperature measurement made by the sensor unit 202B, the temperature that corresponds to the frequency fmaxB2. The detection unit 43 refers the correspondence table T4C in the storage unit 44 and acquires, as the result from temperature measurement made by the sensor unit 202C, the temperature that corresponds to the frequency fmaxC2. The detection unit 43 refers the correspondence table T4D in the storage unit 44 and acquires, as the result from temperature measurement made by the sensor unit 202D, the temperature that corresponds to the frequency fmaxD2. The detection unit 43 associates the acquired measurement results with the sensor units 204 and saves the measurement results in the storage unit 44.

The storage unit 44 may store a correspondence table T4Ax that represents a correspondence relationship between the frequency fminA and the temperature instead of the correspondence table T4A. In this case, the detection unit 43 acquires the frequency fminA in the phase spectrum HS and acquires, as the result from temperature measurement made by the sensor unit 202A, the temperature that corresponds to the frequency fminA in the correspondence table T2Ax.

The detection unit 23 may perform both of “Third Example of Acquisition” and “Fourth Example of Acquisition” described above or may not perform one of “Third Example of Acquisition” or “Fourth Example of Acquisition”.

### [Operation Flow]

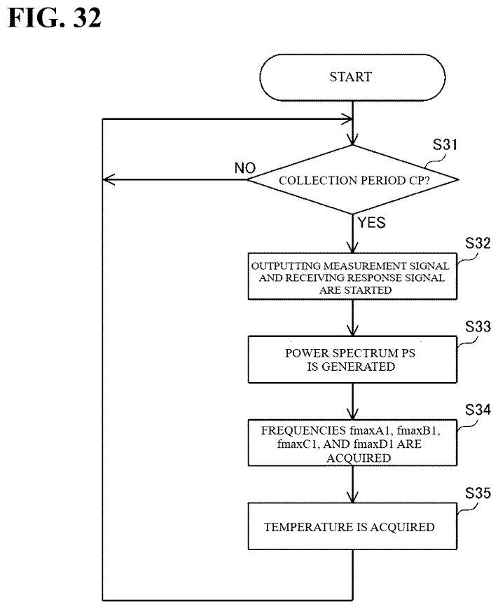

FIG. 32 illustrates a flowchart in which an example of an operating procedure when the collection device according to the second embodiment of the present disclosure acquires the measurement results of the sensor units is defined. FIG. 32 illustrates the flowchart of “Third Example of Acquisition” described above.

Referring to FIG. 32, the collection device 102 first waits until the collection period CP comes (NO at a step S31) and starts outputting the measurement signal and receiving the response signal (a step S32) when the collection period CP comes (YES at the step S31).

Subsequently, the collection device 102 generates the power spectrum PS of the reflection signal that is included in the received response signal (a step S33).

Subsequently, the collection device 102 acquires the frequencies fmaxA1, fmaxB1, fmaxC1, and fmaxD1 in the generated power spectrum PS (a step S34).

Subsequently, the collection device 102 refers the correspondence table T3 and acquires the temperatures that correspond to the frequencies fmaxA1, fmaxB1, fmaxC1, and fmaxD1. More specifically, the collection device 102 acquires, as the result from temperature measurement made by the sensor unit 202A, the temperature that corresponds to the frequency fmaxA1 in the correspondence table T3A, acquires, as the result from temperature measurement made by the sensor unit 202B, the temperature that corresponds to the frequency fmaxB1 in the correspondence table T3B, acquires, as the result from temperature measurement made by the sensor unit 202C, the temperature that corresponds to the frequency fmaxC1 in the correspondence table T3C, and acquires, as the result from temperature measurement made by the sensor unit 202D, the temperature that corresponds to the frequency fmaxD1 in the correspondence table T3D (a step S35).

Subsequently, the collection device 102 waits until the collection period CP newly comes (NO at the step S31).

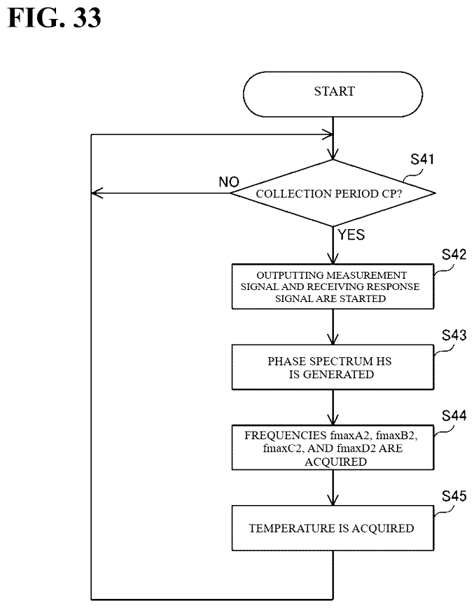

FIG. 33 illustrates a flowchart in which another example of the operating procedure when the collection device according to the second embodiment of the present disclosure acquires the measurement results of the sensor units is defined. FIG. 33 illustrates the flowchart of “Fourth Example of Acquisition” described above.

Referring to FIG. 33, the collection device 102 first waits until the collection period CP comes (NO at a step S41) and starts outputting the measurement signal and receiving the response signal (a step S42) when the collection period CP comes (YES at the step S41).

Subsequently, the collection device 102 generates the phase spectrum HS of the reflection signal that is included in the received response signal (a step S43).

Subsequently, the collection device 102 acquires the frequencies fmaxA2, fmaxB2, fmaxC2, and fmaxD2 in the generated phase spectrum HS (a step S44).

Subsequently, the collection device 102 refers the correspondence table T4 and acquires the temperatures that correspond to the frequencies fmaxA2, fmaxB2, fmaxC2, and fmaxD2. More specifically, the collection device 102 acquires, as the result from temperature measurement made by the sensor unit 202A, the temperature that corresponds to the frequency fmaxA2 in the correspondence table T4A, acquires, as the result from temperature measurement made by the sensor unit 202B, the temperature that corresponds to the frequency fmaxB2 in the correspondence table T4B, acquires, as the result from temperature measurement made by the sensor unit 202C, the temperature that corresponds to the frequency fmaxC2 in the correspondence table T4C, and acquires, as the result from temperature measurement made by the sensor unit 202D, the temperature that corresponds to the frequency fmaxD2 in the correspondence table T4D (a step S45).

Subsequently, the collection device 102 waits until the collection period CP newly comes (NO at the step S41).

As for the collection device 102 according to the second embodiment of the present disclosure, the storage unit 44 stores the correspondence table T3 for every sensor unit 202 but is not limited thereto. The storage unit 44 may store a single correspondence table T3 that represents a correspondence relationship between the frequencies fmaxA1, fmaxB1, fmaxC1, and fmaxD1 and the temperature and that is shared by the sensor units 202. In this case, the detection unit 43 refers the correspondence table T3, acquires, as the result from temperature measurement made by the sensor unit 202A, the temperature that corresponds to the frequency fmaxA1, acquires, as the result from temperature measurement made by the sensor unit 202B, the temperature that corresponds to the frequency fmaxB1, acquires, as the result from temperature measurement made by the sensor unit 202C, the temperature that corresponds to the frequency fmaxC1, and acquires, as the result from temperature measurement made by the sensor unit 202D, the temperature that corresponds to the frequency fmaxD1.

As for the collection device 102 according to the second embodiment of the present disclosure, the storage unit 44 stores the correspondence table T4 for every sensor unit 202 but is not limited thereto. The storage unit 44 may store a single correspondence table T4 that represents a correspondence relationship between the frequencies fmaxA2, fmaxB2, fmaxC2, and fmaxD2 and the temperature and that is shared by the sensor units 202. In this case, the detection unit 43 refers the correspondence table T4 and acquires, as the result from temperature measurement made by the sensor unit 202A, the temperature that corresponds to the frequency fmaxA2, acquires, as the result from temperature measurement made by the sensor unit 202B, the temperature that corresponds to the frequency fmaxB2, acquires, as the result from temperature measurement made by the sensor unit 202C, the temperature that corresponds to the frequency fmaxC2, and acquires, as the result from temperature measurement made by the sensor unit 202D, the temperature that corresponds to the frequency fmaxD2.

The sensor network 302 according to the second embodiment of the present disclosure includes the sensor units 202 instead of the sensor units 201 in comparison with the sensor network 301 but is not limited thereto. The sensor network 302 may include the sensor units 201 and the sensor units 202 that are connected to the detection line 1. In this case, the signal outputting unit 41 of the collection device 102 outputs the measurement signal illustrated in FIG. 4 to the detection line 1 during a collection period CP1 and outputs the measurement signal illustrated in FIG. 22 to the detection line 1 during a collection period CP2 that differs from the collection period CP1. The detection unit 43 acquires the measurement results of the sensor units 201 in accordance with First Example of Acquisition or Second Example of Acquisition described above, based on the response signal that is received by the signal receiving unit 42 during the collection period CP1 and acquires the measurement results of the sensor units 202 in accordance with Third Example of Acquisition or Fourth Example of Acquisition described above, based on the response signal that is received by the signal receiving unit 42 during the collection period CP2.

As for the collection device 102 according to the second embodiment of the present disclosure, the signal outputting unit 41 sweeps the frequency of the measurement signal that is outputted to the detection line 1 in the frequency range that includes the resonant frequencies f2A, f2B, f2C, and f2D but is not limited thereto. The signal outputting unit 41 may output the measurement signal that includes all frequency components in the frequency range that includes the resonant frequencies f2A, f2B, f2C, and f2D to the detection line 1. More specifically, the signal outputting unit 41 may output, as the measurement signal, white noise in the frequency range that includes the resonant frequencies f2A, f2B, f2C, and f2D to the detection line 1 or may output, as the measurement signal, an impulse signal to the detection line 1.

It should be thought that the embodiments are described above by way of example in all aspects and are not restrictive. The scope of the present invention is not shown by the above description but is shown by claims and includes all modifications having the equivalent meaning and scope to those of the claims.

The processes (the functions) according to the embodiments described above may be performed by a processing circuit (Circuitry) that includes one or multiple processors. For example, the processing circuit described above may include an integrated circuit into which one or multiple memories, various analog circuits, and various digital circuits are combined in addition to the one or multiple processors described above. The one or multiple memories described above store a program (a command) that causes the processes described above to be performed by the one or multiple processors described above. The one or multiple processors described above may perform the processes described above in accordance with the program described above and read from the one or multiple memories described above or may perform the processes described above in accordance with a logic circuit that is designed to perform the processes described above in advance. The one or multiple processors described above may be various processors suitable to control a computer such as a CPU (Central Processing Unit), a GPU (Graphics Processing Unit), a DSP (Digital Signal Processor), an FPGA (Field Programmable Gate Array), and an ASIC (Application Specific Integrated Circuit). The multiple processors described above that are physically separated may perform the processes described above in corporation with each other. For example, the processors described above and included in multiple computers that are physically separated may perform the processes described above in corporation with each other via a network such as a LAN (Local Area Network), a WAN (Wide Area Network), or the internet.

The program described above may be installed in the one or multiple memories described above from, for example, an external server device via the network described above or may be distributed with the program stored in a recording medium such as a CD-ROM (Compact Disc Read Only Memory), a DVD-ROM (Digital Versatile Disk Read Only Memory), or a semiconductor memory and may be installed in the one or multiple memories described above from the recording medium described above.

Another aspect of the present disclosure may be a semiconductor integrated circuit that constitutes a portion or the whole of the measurement result acquiring apparatus.

### REFERENCE SIGNS LIST

1 detection line
2A, 2B, 2C, 2D ground node
10 communication unit
20, 40 detection processing unit
21, 41 signal outputting unit
22, 42 signal receiving unit
23, 43 detection unit (acquisition unit)
24, 44 storage unit
30 input/output port
101, 102 collection device
201, 201A, 201B, 201C, 201D, 202, 202A, 202B, 202C, 202D sensor unit
210, 210A, 210B, 210C, 210D, 230, 230A, 230B, 230C, 230D resonant circuit
211, 211A, 211B, 211C, 211D, 214, 214A, 214B, 214C, 214D sensing element
212, 212A, 212B, 212C, 212D inductor
213, 213A, 213B, 213C, 213D capacitor
220, 220A, 220B, 220C, 220D terminal circuit
301, 302 sensor network
N, NA, NB, NC, ND, N1, NIA, NIB, NIC, NID, N2, N2A, N2B, N2C, N2D node
T1, TIA, TIB, T2, T2A, T2B, T3, T3A, T3B, T4, T4A correspondence table
PS1, PS2, PS3 power spectrum
HS1, HS2, HS3 phase spectrum
BL base line

1. A measurement result acquiring apparatus configured to acquire measurement results of multiple sensors including respective resonant circuits,
the resonant circuits including a sensing element a characteristic of which changes depending on a physical quantity of a measurement target,
the measurement result acquiring apparatus comprising:
a signal outputting circuit configured to output a measurement signal having a component of a resonant frequency of the resonant circuits of the multiple sensors to a target line to which the multiple sensors are connected;
a signal receiving circuit configured to receive, from the target line, a response signal including a reflected signal of the measurement signal; and
an acquisition circuit configured to acquire the measurement result of at least one sensor among the multiple sensors, based on the response signal received by the signal receiving circuit.

2. The measurement result acquiring apparatus according to claim 1, wherein resonant frequencies of the resonant circuits of the multiple sensors differ from each other, and
wherein the acquisition circuit acquires the measurement results of the multiple sensors.

3. The measurement result acquiring apparatus according to claim 2, wherein a resistance value of the sensing element changes depending on the physical quantity, and
wherein the signal outputting circuit sequentially outputs, to the target line, the measurement signal corresponding to every one of the multiple sensors.

4. The measurement result acquiring apparatus according to claim 2, wherein a resistance value of the sensing element changes depending on the physical quantity, and
wherein the signal outputting circuit outputs, to the target line, the measurement signal into which multiple signals having different components of the resonant frequencies are synthesized.

5. The measurement result acquiring apparatus according to claim 3, further comprising:
a storage circuit configured to store first correspondence information representing a correspondence relationship between amplitude of the response signal and the physical quantity for every one of the multiple sensors,
wherein the acquisition circuit acquires, as the measurement results of the multiple sensors, the physical quantity corresponding to the amplitude of the response signal received by the signal receiving circuit, based on the first correspondence information corresponding to every one of the multiple sensors.

6. The measurement result acquiring apparatus according to claim 3, further comprising:
a storage circuit configured to store second correspondence information representing a correspondence relationship between a phase of the response signal and the physical quantity for every one of the multiple sensors,
wherein the acquisition circuit acquires, as the measurement results of the multiple sensors, the physical quantity corresponding to the phase of the response signal received by the signal receiving circuit, based on the second correspondence information corresponding to every one of the multiple sensors.

7. The measurement result acquiring apparatus according to claim 2, wherein a capacity value of the sensing element changes depending on the physical quantity, and
wherein the signal outputting circuit sweeps a frequency of the measurement signal to be outputted to the target line in a frequency range including the resonant frequencies differing from each other.

8. The measurement result acquiring apparatus according to claim 2, wherein a capacity value of the sensing element changes depending on the physical quantity, and
wherein the signal outputting circuit outputs, to the target line, the measurement signal including all frequency components in a frequency range including the resonant frequencies differing from each other.

9. The measurement result acquiring apparatus according to claim 7, further comprising:
a storage circuit configured to store, for every one of the multiple sensors, third correspondence information representing a correspondence relationship between a frequency at a change point in a power spectrum of the response signal and the physical quantity of the measurement target for every one of the multiple sensors,
wherein the acquisition circuit acquires, as the measurement results of the multiple sensors, the physical quantity corresponding to the frequency at the change point in the power spectrum of the response signal received by the signal receiving [unit] circuit, based on the third correspondence information corresponding to every one of the multiple sensors.

10. The measurement result acquiring apparatus according to claim 7, further comprising:
a storage circuit configured to store, for every one of the multiple sensors, fourth correspondence information representing a correspondence relationship between a frequency at a change point in a phase spectrum of the response signal and the physical quantity of the measurement target for every one of the multiple sensors, wherein the acquisition circuit acquires, as the measurement results of the multiple sensors, the physical quantity corresponding to the frequency at the change point in the phase spectrum of the response signal received by the signal receiving circuit, based on the fourth correspondence information corresponding to every one of the multiple sensors.

11. A method of acquiring a measurement result for a measurement result acquiring apparatus configured to acquire measurement results of multiple sensors including respective resonant circuits,
the resonant circuits including a sensing element a characteristic of which changes depending on a physical quantity of a measurement target,
the method comprising:
outputting a measurement signal having a component of a resonant frequency of the resonant circuits of the multiple sensors to a target line to which the multiple sensors are connected; and
receiving, from the target line, a response signal including a reflected signal of the measurement signal; and acquiring the measurement result of at least one sensor among the multiple sensors, based on the received response signal.

12. A measurement system comprising: multiple sensors including respective resonant circuits; and
a measurement result acquiring apparatus configured to acquire measurement results of the multiple sensors,
the resonant circuits including a sensing element a characteristic of which changes depending on a physical quantity of a measurement target,
the measurement result acquiring apparatus including:
a signal outputting circuit configured to output a measurement signal having a component of a resonant frequency of the resonant circuits of the multiple sensors to a target line to which the multiple sensors are connected;
a signal receiving circuit configured to receive, from the target line, a response signal including a reflected signal of the measurement signal; and
an acquisition circuit configured to acquire the measurement result of at least one sensor among the multiple sensors, based on the response signal received by the signal receiving circuit.
